(19) United States
(12) Patent Application Publication
(10) Pub. No.: US 2015/0100168 A1
(43) Pub. Date: Apr. 9, 2015

(54) PLANT PROFILE WATER MANAGEMENT SYSTEM

(71) Applicant: Ian James Oliver, Mawson (AU)

(72) Inventors: Ian James Oliver, mawson (AU); Stephen Edward Ecob, Chatswood (AU)

(21) Appl. No.: 14/485,683

(22) Filed: Sep. 13, 2014

Related U.S. Application Data
(60) Provisional application No. 61/877,743, filed on Sep. 13, 2013.

(51) Int. Cl. A01G 25/16; H04W 4/00

(52) U.S. Cl. CPC A01G 25/167; H04W 4/005
USPC 700/284

(57) ABSTRACT

A plant profile water management system includes a water controller delivering water to a plant, a processor coupled to the water controller, and a mobile computing device coupled to the processor by a radio link. The mobile computing device communicates a plant type profile to the processor. The processor executes the rules according to said plant type profile to control the timing and quantity of water flow output to the plants.

### BACKGROUND

Plants may require careful management depending on environmental conditions as well as the needs of the plant itself. Factors such as the amount of water, sunlight, temperature, soil type as well as the plant's own changing requirements with, for example, the change of seasons and age of the plant should be monitored and regulated to promote optimal plant health. Often many factors must be correctly controlled to maintain the optimum health of the plant. To provide optimal care for a plant, a set of parameters specifying the ideal conditions and an acceptable range as well as a set of rules to observe when conditions are not ideal for each plant should be followed. The rules depend on the occurrence of an event, for example detection of low soil moisture and specify some instructions to follow to remediate the situation.

The passing of time, the time of year, initial placement of the plant in soil, or the plant reaching a certain age may all be events. It is difficult for a plant care person(s) to remember to monitor which events have occurred, measure the event, and know the action to take. It is also difficult for a plant care person(s) to choose the correct plant for environmental conditions. Much of the gardening industry is devoted to providing this kind of advice. Children need encouragement to remember to care for plants and enjoy nurturing them. Electronic games distract children from traditional pass times such as caring for plants and there is a need to help them re engage with out door activities such as gardening.

### SUMMARY

Embodiments of a system are described. In one embodiment, the system is a plant monitoring system. The system includes a sensor device for placement near one or more plants, with multiple sensors including for example, moisture, light, and temperature, a mobile computing device with a local or remote database of properties and rules comprising of conditions and actions for lifecycle stage for the plant, referred to as plant type profile or plant profile, to be monitored and environment adjusted. Where said mobile computing device includes a display to select the plant type, monitor the plant, configure plant properties and rules comprising of conditions and actions for lifecycle stages, and share with, and download from other users. The sensor device is associated with one or more different plants. The sensor device reads multiple sensor environment information such as soil moisture, light, humidity and temperature. In the case of moisture monitoring as one example of a many possible measureable sensor values, the system consults the ideal soil moisture range for the plant from a database of properties and rules comprising of conditions and actions for lifecycle stages of the plant. The system tries to determine whether watering is required and how much, using rules to calculate the difference between the sensed values, for example, soil moisture and the ideal value as described in the properties for the plant and if rule conditions evaluate to true then instructions or action to be applied dependent also on the lifecycle of the plant, and send these instructions or actions to a user for watering amounts or an automated water device. The sensor device or the Mobile computing device communicates instructions to the user informing how to care for the plant. Other embodiments of the system are also described.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts one embodiment of a device that contains a multiplicity of a variable number of sensors, sensor conditioning circuits including analogue to digital converters, display, input, processor and communication modules capable of communication on lower RF such as Bluetooth and Bluetooth low energy. The device casing may come in many different sizes and enclosure designs including various different attachment options for moisture measurement probes including, but not limited to Capacitance and conductivity based measurements, including the ability to simultaneously measure multiple zones.

FIG. 2 depicts one embodiment of a device that can connect to the sensor device described in FIG. 1 and issue an audio or visual alert to a user when it receives a signal from the sensor device in FIG. 1 or send commands to the sensor device in FIG. 1.

FIG. 3 depicts one embodiment of a Mobile Computing device that can connect to the sensor device described in FIG. 1 and issue an audio or visual alert to a user from the sensor device in FIG. 1. The possible interconnection between the devices could include internet, using low power wireless networks such as Bluetooth and Bluetooth low energy, wifi, and wire.

FIG. 4 depicts one embodiment of a way in which plant care instructions are communicated to plant care person(s).

FIG. 5a depicts one embodiment of the downloading of a plant care profile from a remote service to the sensor device described in FIG. 1 by use of a Mobile Computing device. The possible interconnection between the devices could include internet, using low power wireless networks such as Bluetooth and Bluetooth low energy, wifi, and wire.

FIG. 5b depicts one embodiment of the downloading of a plant care profiles such as 1899 or 1999 from a remote service to the sensor device described in FIG. 1 by use of a Mobile Computing device where a codes, not limited to QR or barcodes are used to identify the profile to download. The possible interconnection between the devices could include internet, using low power wireless networks, wifi, and wire.

FIG. 6 depicts one embodiment of the possible configurations in which the moisture sensing can operate.

FIG. 7 depicts one embodiment of the process for checking of an individual plant and watering if required.

FIG. 8 depicts one embodiment of a moisture distribution of a plant pot with poor drainage resulting in a wet pot base.

FIG. 9 depicts one embodiment of testing soil at a location to determine characteristics so that suitable plant can be chosen for location.

FIG. 10 depicts one embodiment of the possible sensor interconnection techniques.

FIG. 11 depicts one embodiment of a possible use of the system in side a terrarium or similar closed or semi closed system.

FIG. 12 depicts one embodiment of information in the form of a graph of moisture change over time displayed to the user on a device such as a mobile computing device.

FIG. 13 depicts one embodiment of the retrieval of weather data from a server.

FIG. 14 depicts one embodiment of a water control value which can receive instructions using low power RF communications such as Bluetooth or Bluetooth low energy.

FIG. 15 depicts one embodiment of a flow chart of the association of plant sensor with a plant and matching plant type profile such as 1899 or 1999 followed by the plant sensor measurement and comparison to plant profile properties, generating alert and display of action information to the user when differences are found between desired profile properties and the measured values.

FIG. 16 depicts one embodiment of a plant care label with QR or barcode.

FIG. 17 depicts one embodiment of a device that contains a multiplicity of a variable number of QR or barcodes on gardening soils, fertilisers and other items.

FIG. 18 depicts one embodiment of a plant type profile for a succulent plant. The profile specifies properties and corresponding rules comprising of conditions and actions for different stages of the lifecycle of the plant.

FIG. 19 depicts one embodiment of a plant type profile of a strawberry plant. The profile specifies the properties and corresponding rules comprising of conditions and actions for different stages of the lifecycle of the plant.

FIG. 20 depicts one embodiment of system allowing access to the plant sensor data, associated plant profiles and alerts for a plant sensor device from all types of fixed and mobile computer devices in a local area and from a remote location.

FIG. 21 depicts one embodiment of a setup to measure the reflective response of the leaf on a plant to a visible, near-infrared and infrared light source by a visible sensor and infrared and near infrared sensor mounted on the device.

FIG. 22 depicts one embodiment of a setup to measure the reflective response of the leaf on a plant to a visible, near-infrared and infrared light source being the sun by a visible sensor and infrared and near infrared sensor.

FIG. 23 depicts one embodiment of a graph of one example of a reflection response of a plant leaf and foliage to visible, near-infrared and infrared light.

FIG. 24 depicts one embodiment of a system where a plant sensor or retail device can transmit a code to be detected by “google glass” or similar devices causing the display of product information on “google glass”.

FIG. 25 depicts one embodiment of a graphical based system for defining a plant profile as an alternative to code based approach. Settings can be made for properties such as, but not limited to Moisture/watering needs, Ideal Temperature and sunlight for the plant as well as reminders for fertilising can be configured by selecting symbols representing the properties and Conditions required

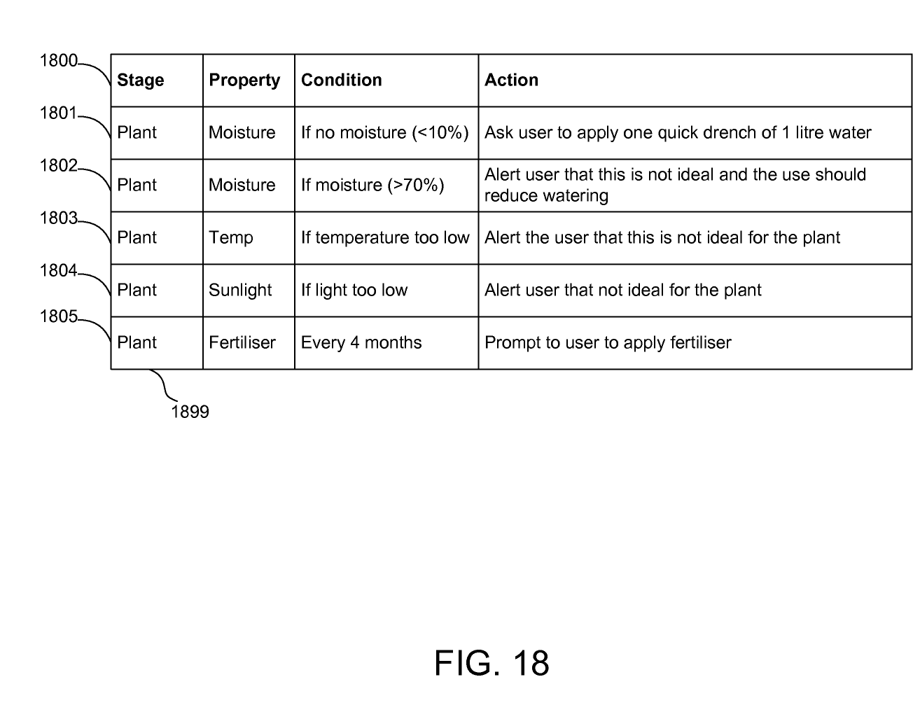

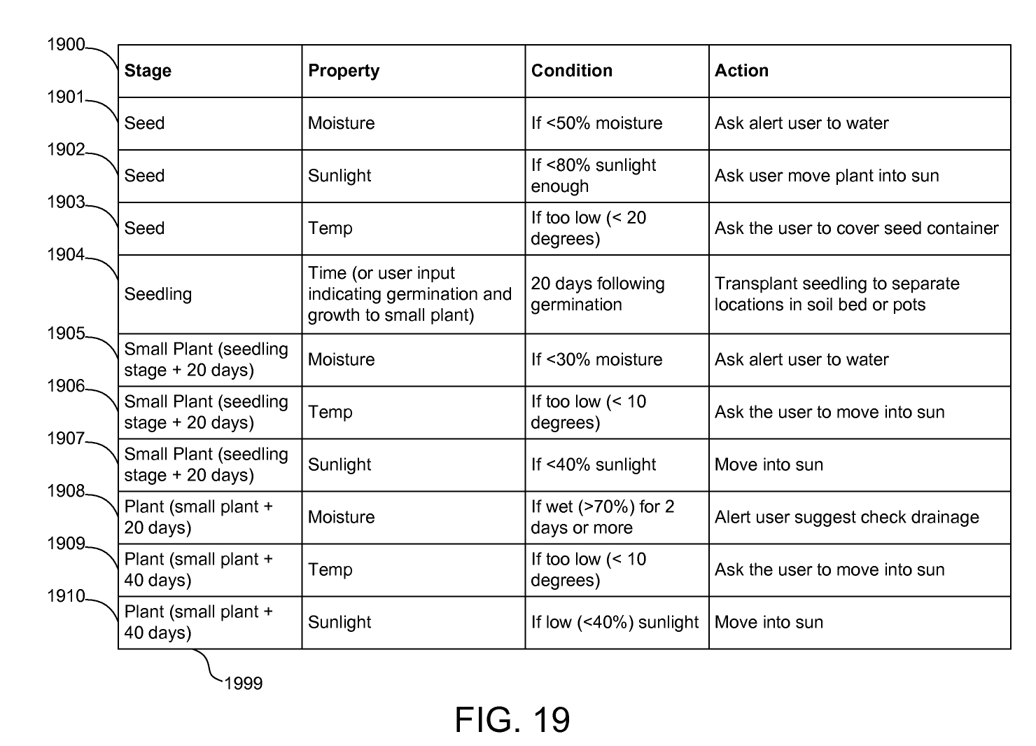

Throughout the description, similar reference numbers may be used to identify similar elements. The term profile, plant profile and plant type profile are used interchangeably to refer to profiles such as 1899 or 1999 described FIG. 18 and FIG. 19. Where ever reference to plants is made this includes trees, grass, seeds and all other kinds of plants and vegetation including fruit trees, fruits and flowers etc The term mobile computing device, smart device, tablets are used interchangeably,

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

Moisture varies with depth. Water sitting at the root level causes problems. It is difficult to ascertain specifically root moisture as opposed to overall moisture because simple meters only contain one sensor that returns overall moisture. Commercial moisture meter models allow setting and measurement of moisture at set intervals but this requires adjustment and measurement at each depth. The rate of flow of the water (drainage) is an important property that is not measureable unless multiple zones are concurrently measured. Often, depending on plant age ideal watering is shorter, deep soaking to promoting root growth. It is easy to forget to do this, or to over water a plant. The soil composition including also how compact the soil is, has a significant effect on the way that water moves through the soil (drainage) and so benefits or robs the plant of moisture. Timing of watering is important. Watering in the early morning or to a lesser extent after the sun goes down are best for plants. It is easy to not know this or forget. Future weather events influence the care that should be given to a plant in advance of the time the event occurs. For example, although a plant may need watering at a point in time if it will rain in after an hour the present watering is unnecessary. Plants require varying amounts of watering depending on the type of plant, age, and soil type, tomorrow's weather. Encouraging children to water plants is important goal. When the child can feel that they can interact with the plant as if the plant is communicating with them or receive points for looking after the plant they begin to learn the habits needed for good gardening. The system can also be used to encourage children to garden. Children's imagination and interest is focused on technology such as mobile computing devices, smart devices and tablets and particularly on game content. Children do enjoying gardening but find it hard to learn the discipline to care for plants. Parents wish to engage kids in outside activities. They often choose to take on rent and debt to provide backyard environment for children they value experiencing like gardening so highly. Presently plants have instruction labels for care and the internet and books are helpful to learn how to care for plants however it is still very difficult to remember to monitor the plant and also to apply the appropriate caring instructions according to monitored values as well as determine the state of the plant without sensors. Additionally, time related activities may need to remembered and performed. Choosing Plants to plant at a location, and understanding how the lighting, rainfall, availability of the gardener, season at the location including GPS position as well as the soil characteristics as some example factors is difficult involving many parameters. Beyond plants watering needs there are other factors which influence their growth and health. The amount of sunlight, humidity, air and soil temperature at multiple depths, pH and the amount of fertilizer can also play a role in the plant health. Too much or little sunlight, temperature highs and lows, pH imbalances and lack of fertilizer are factors that should be accounted for but through garden inexperience, busyness and failure to remember they can ruin plants. Again forecast weather events for all these factors, can be useful to proactively safe guard plants but it is not always possible to be aware of these future conditions. Humidity can also effect a plant both negative and positively. Seedlings are very sensitive to heat stress which may kill the delicate sprout as such they require a different profile to alert for temp and alert to avoid future severe weather events. A central activity in the gardening industry is the provision of advice and education for the growing plants including both the initial selection of plants for a garden, as well as ongoing care for the plants. These education functions are fulfilled through TV programs, magazine, forums, nurseries and industries sharing information. Sharing is as such an integral part of gardening. Significant business is generated centered around these activities.

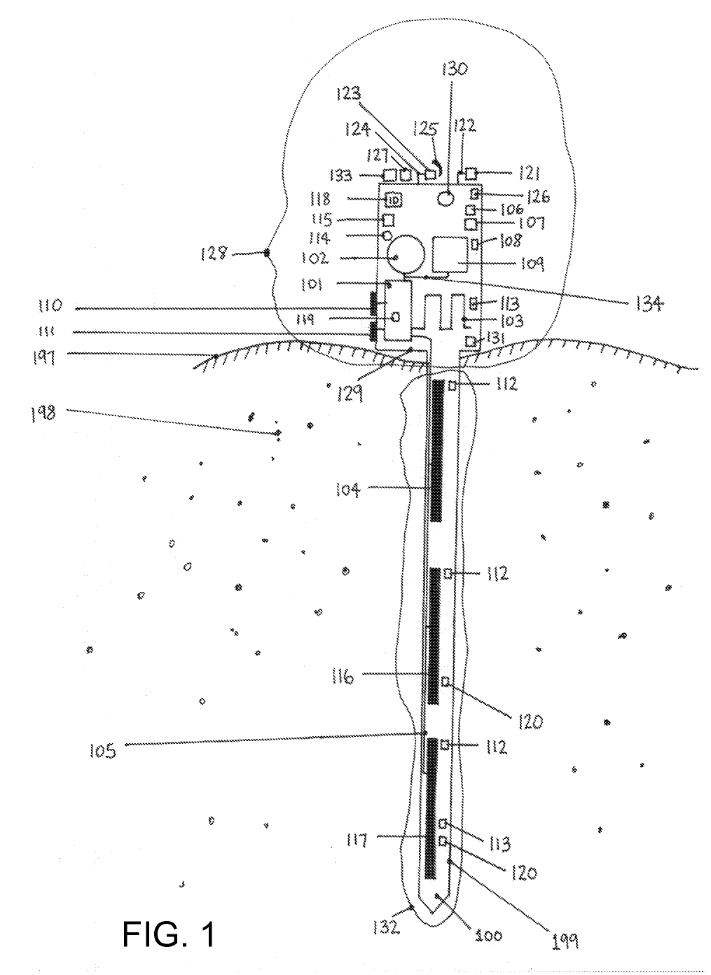

FIG. 1 depicts one embodiment of a plant sensor device that contains a multiplicity of a variable number of sensors, display, input, processor and communication modules 101 and antenna 103. Power for the sensor is provided by a battery 102 or solar panel 109 which may internally also use a capacitor to store energy. The device casing 100 may come in many different sizes and enclosure designs including various different attachment options for moisture measurement sensors including, but not limited to capacitance and conductivity and electrical resistance based measurements on one or more zones including the upper 104, middle 116 and lower or root 117. Those skilled in the art will be familiar both techniques for moisture measurement by capacitance and conductivity and electrical resistance measurement. Other known techniques for moisture measurement for plants may also be employed.

In addition to soil moisture measurement sensors 104, 116 and 117 other sensors on the plant device include, light sensor 106, temperature sensor 107, humidity sensor 108, light sensors 112 which can be used to check how many zones are below the surface of the soil and so disregard zone not in soil or understand whether the reading relates to above or below the ground. This allows the device to know which zones are in the soil so that values for zones not in the soil can be ignored. Temperature sensor 113 at bottom of probe that can also be used for seed soil temperature checking, pH sensor 120, accelerometer used to measure movement 121, wire connector for accelerometer 122, infrared sensor 123, infrared lens 125 so that especially if the sensor is mounted away form the plant to obtain the overall plant or an individual leaf or leaves, infrared or other light range emitter source 126 for emitting onto a leaf for measurement of infrared reflection, Air pressure sensor 127 including for prediction of weather events and changes, anemometer

Various wires and connectors interconnect section of the device, including wire connector 110 to interface to additional plant sensor devices 199, I2C or similar protocol connectors 111 to interface to additional 199 devices and other sensors and electrical connection 105 from 104, 116, 117 to 101. As well as wire connector 122 for accelerometer 121 and wire connector 124 and support for infrared sensor 123 and lens 125, the support can be used to set the infrared sensor 123 close up to a leaf, or with infrared lens 125 so that especially if the sensor is mounted away from the plant or group of plants then the lens can allow a wide body view of all the plants to measure reflected infrared from sunlight or infrared or other light range emitter source 126 or emitting onto a leaf for measurement of infrared reflection.

Software 119 runs on the processor unit 101 to take sensor readings and send to the mobile computing device 399 as well as receive commands from the Mobile Computing device and give visual alerts 115 and audio alert 114 to the user. An audio output for alert user 114, for example if the moisture for any plants associated with the device 199 need watering is provided. A Visual, light output for alert user 115, for example if the moisture for any plants associated with the device 199 need watering is provided. The Software 119 can take a database of plant profile information and cross reference this information with the measurements from the plant sensor device as well as information received via the Mobile Computing Device and determine alerts to send to a user and or other devices connected by electrical wire or wirelessly to the plant sensor device 199. The database of plant type profiles information may be stored on the plant sensor device 199, or on the Mobile computing device 399 or remotely in a database 500 as plant type profiles 501. Each plant type profile 501 stored the following information for a particular plant type. The profile specifies for each stage of the lifecycle of the plant, particular properties to monitor such as temperature as well as rules comprising of conditions and actions to evaluate changes to those properties and resultant actions to perform when particular conditions are met. For example for the temperature property a condition and action may be to alert the user if the temperature falls below 5 degrees Celsius. Also each particular plant being monitored has its own unique history such as age, previous watering and heat exposure and resultant stress.

For identification of the plant sensor device with the physical surroundings for the user to identify the device has a device number label 118. The probe 199 is placed into the soil surface 197 and soil 198 for the purpose of measurement up to the point which is the base 129 or the top section 128 of the plant sensor device 129. The plant sensor is fitted with a camera 130 capable of day and night time photo and video recording and storage in memory. The plant sensor device 199 may contain one or more of the sensors described.

Referring to FIG. 1, The plant sensor device can measure all sensors values simultaneously. Moisture sensor values are determined corresponding to 100% moisture graduating down to 0% moisture. The plant sensor 199 is created with multiple zones 104, 116, 117 which can simultaneously measure moisture. The lowest zone can measure root moisture and each sensor 104,116,117 the length of time the water remains. Depending on a plant profile and the soil moisture they require at different levels of the plant an alert can be generated if the moisture readings are outside healthy time limits or saturation levels. The device may have the ability to simultaneously measure moisture multiple zones or a single zone depending on the desired configuration. The probe may be capable to measure moisture simultaneously using different measurement techniques such as Capacitance and conductivity and resistance based measurements.

Referring to FIG. 1, In one embodiment three moisture zones are measured, under soil 104, middle depth of plant 116, root level 117. The device may also log the age of the plant and attempt to predict at what depth the root level is located so as to advise on root moisture as well as moisture levels adjusted specifically to the plant's predicted depth in the soil.

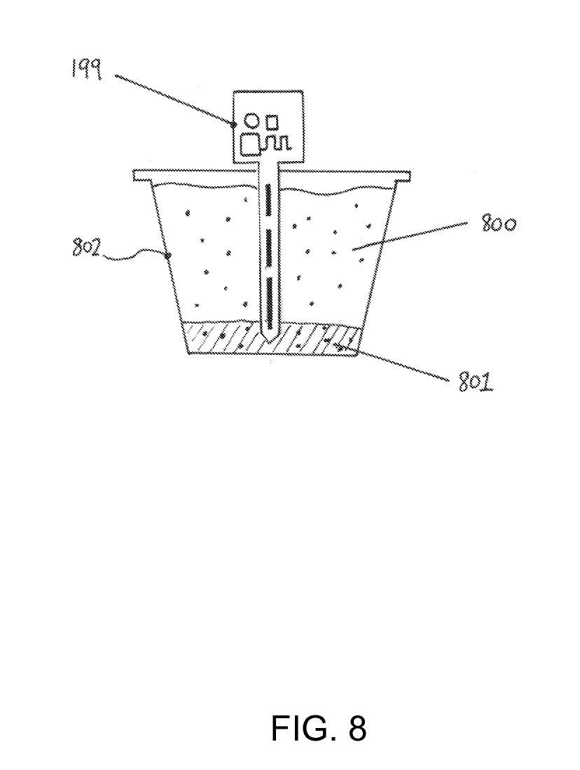

In another embodiment more than three zones, for example, five zones, above soil leaves, top of soil (soil level) 131, under soil, middle depth plant, root level can be measured. The determination of moisture may be made by averaging the moisture values, or alternatively taking worst case (for example if the root level is water laden) and so report this as the significant reading for action. FIG. 8 shows a pot where the base of the pot has a continually high water content which can be measured by a portion of device 199's root level sensor.

Water retention of the soil and water flow (drainage) can be measured because the device 199 can be constructed with multiple levels through which over time the passage of water as indicated by changes in capacitance, resistance or other such methods can be measured. If the water retention of the soil measure does not correspond to the plant types profile requirements the user can be alerted to change to soil type.

The Accelerometer 121 can be used to measure interference to a plant by an animal or human when the they knock the sensor or if they knock the plant by way of the mounting of the accelerometer 121 on the plant using a wire connection 122. The infrared sensor 123 can be used as a passive infra-red sensor at night to detect animals or humans interfering with the plant. When interference is detected the sensor may use its visual or audio alert mechanisms to deter the interferer as well as alert the user via initiating a connection to the Mobile computing device 399 or taking and storing a picture using a camera 130. The probe section 132 is the part of the plant sensor device which is pushed into the soil. An infrared sensor 123, can be connected by a wire connector 124 that supports the infrared sensor 123, the support can be used to set the infrared sensor 123 close up to a leaf, an and infrared lens 125 used so that especially if the sensor is mounted away from the plant or group of plants then the lens can allow a wide body view of all the plants. An infrared or other light range emitter source 126 for emitting onto a leaf for measurement of infrared reflection. The sun may also be used as a source of infrared. An anemometer 127 or similar wind flow device is used to measure the airflow near the plant as wind flow can affect the health of the plant.

Other moisture related issues which could be alerted include the moisture being out side of a range acceptable for the plant at any depth in the soil where the moisture may be either dryer or wetter than expected. Another moisture issue that may be reported is if the moisture passes through the soil too quickly and this doesn't suite the plant type. Another moisture issue that may be reported is if the moisture passes through the soil too quickly and this doesn't suite the plant type. Another moisture issue that may be reported is that there is consistently too much water entering the soil as some plant types for example develop better root systems when they are watered in distinct water events where more water is delivered in one go similar to the falling of rain. Other moisture issues that may be reported would be when the soil is not consistently damp as this may be needed by some plant type from rain forest type environments where there is continually moist soil.

Some plants and seeds require a moist soil, in which case well draining soil used for these seeds may require more watering. In addition to using the data about the movement of the water through the soil to determine the characteristics of the soil, the user can also be informed if the watering of the plants in terms of frequency and volume is not ideal. For example deeper soakings less frequently would offer better plant health. Depending on the plant needs this data may indicate that the soil is suitable or alternatively that changes need to be made. The data to demonstrate this to the user may be transmitted from the plant sensor device 199 to the mobile computing device 399

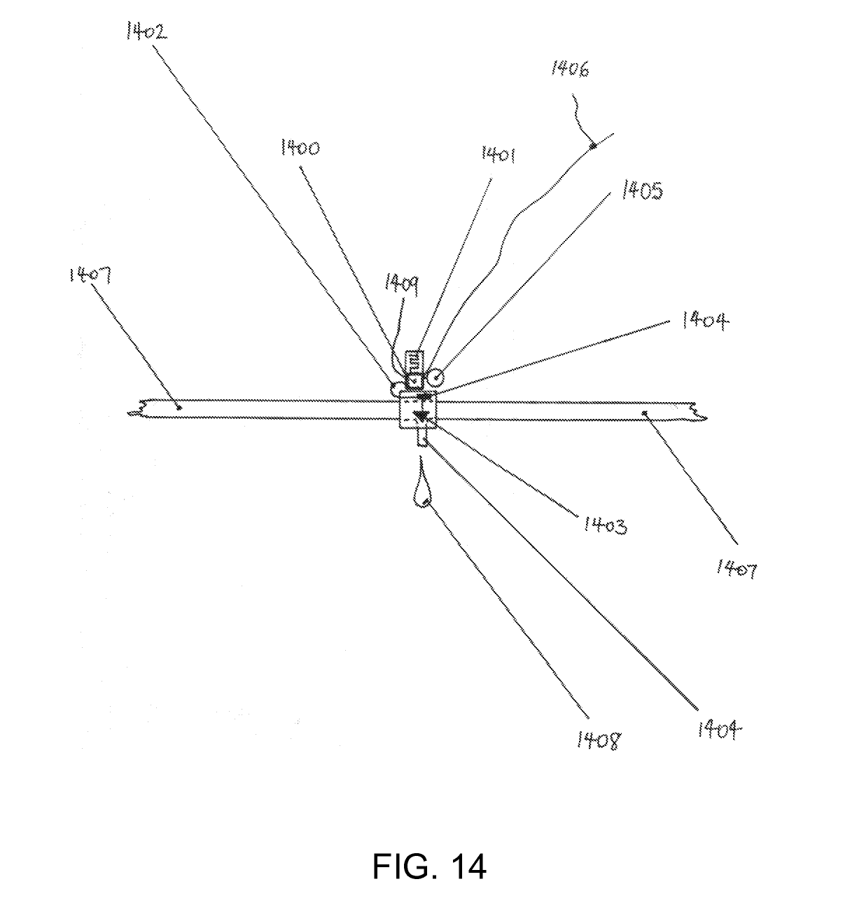

The user may be unaware or forgetful of the plants needs for water. Software on the device 199 will periodically check sensor values or receive interrupts when the sensor values measure determined values. When the plant sensor device 199 wishes to warn the user that attention is required based on sensor values, it can attempt to connect to the user's mobile computing device 399 in various ways but primarily via Radio such as a low power RF directly or the internet or mobile network and provide information about the urgency of watering. Neighbours by any of these ways or a plant maintenance company may be configured to receive this information for example if the user is away from the house. Where possible, the application 302 on the Mobile Computing Device 399, running as a foreground or background task or service or in other ways using the operating system of the Mobile Computing Device can monitor for said connection to communicate the warning from the plant sensor device 199 and display a warning to the user on the Mobile Computing device 399 or control equipment for plant care including watering as shown in FIG. 14.

In another embodiment, the application 302 on the mobile computing device 399 can initiate the checking of values. In this configuration, the device 199 must periodically check for connection attempts initiated from the device 399 or in other ways receive interrupts if a connection is attempted.

These described method of connection initiation and reception between the sensor device 199 and Mobile computing device 399 can be used for warning, alerts and exchange of all the various sensors values as wail as for updating data and warnings and alerts.

Referring to FIG. 1, three zones are described, 104, 106, and 117, in alternative embodiment there can be 1 to many zones (in excess of 3), In one embodiment, the sensor device 199 detects the time watering is done. The device knows when the user does the watering if a watering device has been detected to have been used as indicated by a generation of a signal from a processor 703 attached to a watering device 701 otherwise assumes it is due to the rain. Weather data can also be used to check if there may have been rain and sufficient quantity to have cause the new moisture sensed. The device 199 uses this data to attempt to deduce when the user watered and based on these watering habits such as time of day, frequency and quantity advises the user on possible improvements, for example not to water middle of the day.

For reference with FIG. 1,
100—plant sensor casing including the probe casing.
101—processing unit. It contains software instructions to execute all the functions described for the device 199. It also generates the communications for transfer of sensor data using, but not limited to, low power RF conforming to standards such as Bluetooth 4, Bluetooth low energy and Bluetooth. The processing unit may also include an analogue to digital converter to convert sensor values.
102—battery or capacitor
103—antenna, supports but not limited to, low power RF conforming to standards such as Bluetooth 4, Bluetooth low energy and Bluetooth.
104—upper zone capacitance and or electrical resistance and or conductance measurement section for moisture measurement.
105—electrical connection from 104, 116, 117 to 101.
106—light sensor
107—temperature sensor
108—humidity sensor
109—solar panel
110—wire connector to interface to additional 199 devices.
111—electrical I2C connector to interface, or similar connection protocols, to additional 199 devices and other sensors.
112—light sensors which can be used to check how many zones are below the surface of the soil. This allows the device to know which zones are in the soil so that values for zones not in the soil can be ignored.
113—temperature sensor at bottom of probe that can be used for seed soil temperature checking
114—audio output for alert user, for example if the moisture for any plants associated with the device 199 need watering
115—one or more light output for alert user, for example if the moisture for any plants associated with the device 199 need watering. It can also be used to output visible light for reflectance testing.
116—middle zone capacitance and or resistance and or conductance measurement section for moisture measurement.
117—lower (root) zone c capacitance and or resistance and or conductance measurement section for moisture measurement.
118—device number label for identification of the unique device
119—Software, on the sensor device which runs the profile
120—pH measurement sensor
121—accelerometer used to measure movement
122—wire connector for accelerometer 121
123—one or more near-infrared and infrared thermometers or sensors.
124—wire connector and support for infrared, near-infrared and visible, the support can be used to set the infrared sensor 123 and lens 125 close up to a leaf
125—one or more infrared lens so that especially if the sensor is mounted away from the plant or group of plants then the lens can allow a wide body view of all the plants. Different lens can also be used to filter out different wave lengths from visible, infrared and near-infrared light.
126—one or more near-infrared or infrared or visible or other light range emitter source for emitting onto a leaf for measurement of infrared reflection
127—Air pressure measurement including for prediction of weather events and changes.
128—top section of the sensor which stays above the soil
129—base of the tope section of the sensor 128
130—camera
131—above soil (soil level) capacitance and or resistance and or conductance measurement section for moisture measurement.
132—probe section which typically goes into the soil.
133—anemometer
134—connection 102,109 and 101.
197—soil surface
198—soil
199—entire probe 100 to 117.

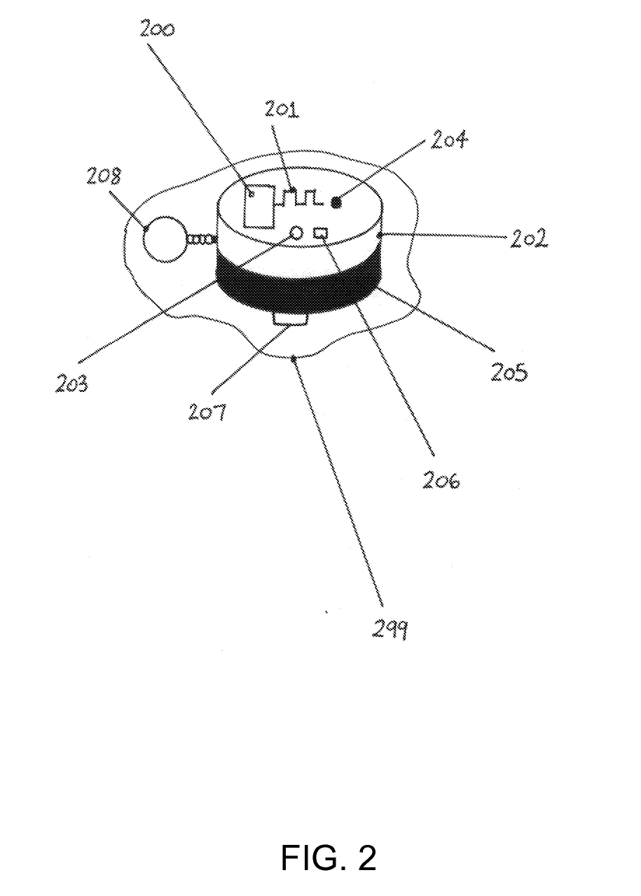

FIG. 2 depicts one embodiment of a portable alert device which can receive an alert from a sensor device when a plant needs attention. A processing unit 200 contains software instructions to execute functions for the portable alert device 299 including receiving alerts from a plant sensor device 199. It also generates the communications for transfer of sensor data using, but not limited to, low power RF conforming to standards such as Bluetooth 4, Bluetooth low energy and Bluetooth. An antenna 201, supports but not limited to, low power RF conforming to standards such as Bluetooth 4, Bluetooth low energy and Bluetooth. A case 202 holds all the components together can be packaged in many ways including an engaging manner for children. A display 203 using for example LEDs, a sound output to inform the user of an alert audibly, a button 204, to cancel alerts by both 203 and 206. A battery source 205, Attachment 207 such as adhesive or Velcro and Attachment clip 208, such as key ring.

In FIG. 2, when the plant sensor device 199, detects that there is an action to perform to care for a plant that requires the user to take action such as water the plant or improve drainage, then device 199 can communicate directly to the Mobile computing device 399 if the device and software is capable to receive an alert including using a foreground or background monitoring and connection or alternatively to device 299. In one implementation the device 299 polls for updates from the device 199 at intervals which may also be predetermined so as to minimise battery use by unnecessary communication attempts. Device 299 will then produce an indication to the user such as led 203, buzzer 206 that the user can acknowledge by pressing the button 204.

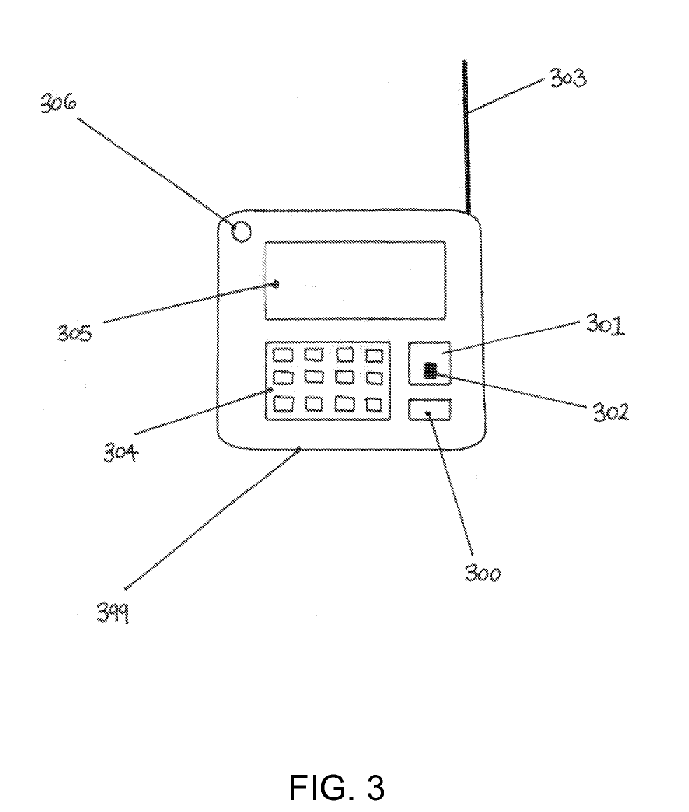

Pressing a button 204 it can also request an update from the plant. For some operating systems and hardware it is not possible for the Mobile Computing Device to receive an unsolicited connection or poll for connections to a device in the background or if it is possible to have the application process information from a connection without interaction, or maintain under all circumstances a connection between the device 199 and the Mobile Computing Device 399. Presently iOS© has some limitations in these areas but Android allows implementation of monitoring from the Mobile Computing Device for alerts from the background tasks. For these reasons the device 299 allows a methods for alerting which is useful in circumstances such as where the user own an iOS system or such similar system where Mobile Computing Device side monitoring in the background is not possible. Referring to FIG. 3, in a further example, the device 299 listens for updates from 199 and when the device 199 makes it's device visible via the wireless or makes a connection attempt to 299 then an alert can be received and displayed to the user via 299.

For reference with FIG. 2,
200—processing unit. It contains software instructions to execute all the functions described for the device 299. It also generates the communications for transfer of sensor data using, but not limited to, low power RF conforming to standards such as Bluetooth 4, Bluetooth low energy and Bluetooth.
201—antenna, supports but not limited to, low power RF conforming to standards such as Bluetooth 4, Bluetooth low energy and Bluetooth.
202—Case
203—Display, for example, LEDs
204—Button
205—Battery or capacitor
206—Sound output, for example, piezo electric buzzer
207—Attachment such as adhesive or Velcro
208—Attachment clip, such as key ring
299—portable plant alert device

FIG. 3 depicts one embodiment of a Mobile Computing Device which can receive communications from a plant sensor device for alerting the user or for the purpose of calculation, and can also push property values for plant care to the plant sensor as well as retrieve property values, and rules comprising of conditions and actions or instructions from a local database on the Mobile Computing Device or remote server.

The connection between the plant sensor device 199 and the application 302 on the mobile computing device 399 can be established in a number of different ways when two devices are in proximity. Firstly, The user may open the application, or perhaps prompted by a timer, and the application 302 on the mobile computing device 399 will attempt to pair to the plant sensor 199 and check if there are any new measurements or updates to alerts for user. Secondly, An application 302, such as a service, on a mobile computing device 399 may regularly check to see if the plant sensor 199 is attempting to communicate or able to respond to a connection attempt. The mobile computing device can communicate with a remote server using the internet or low power RF and retrieve or upload plant care properties, rules comprising of conditions and actions or instructions. The mobile device 399 can transfer plant profile information to the plant sensor device 199 from where the plant sensor device 199 can process monitor properties against measured sensor values, and when conditions are evaluated perform an action.

The profile specifies the for the stage of the plant, particular properties to monitor as well as rules (or conditions) to apply to evaluation changes to those properties and resultant actions for perform when particular conditions are met.

For reference with FIG. 3,
300—processing unit. It contains software instructions to execute all the functions described for the device 199. It also generates the communications for transfer of sensor data using, but not limited to, low power RF conforming to standards such as Bluetooth 4, Bluetooth low energy and Bluetooth.
301—memory
302—plant sensor Application software for the mobile computing device side.
303—antenna, supports but not limited to, low power RF conforming to standards such as Bluetooth 4, Bluetooth low energy and Bluetooth as well ad Mobile Device communication protocols including but not limited to 3G or 4G, internet and wifi
304—Keyboard as software or hardware
305—Display
306—camera
399—mobile computing Device including plant sensor application software. Mobile computing devices include tablets, smart phones, Mobile Phones, laptops, “google glass” supports but not limited to, low power RF conforming to standards such as Bluetooth 4, Bluetooth low energy and Bluetooth as well as Mobile Device communication protocols including but not limited to 3G or 4G, internet and wifi.

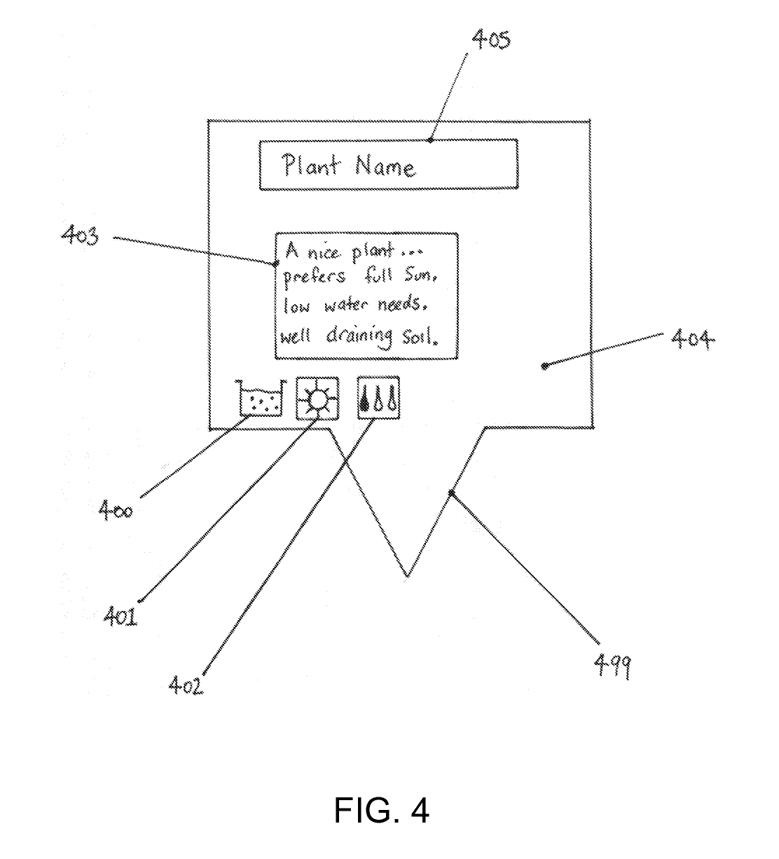

FIG. 4 depicts one embodiment of a method to communicate plant caring instructions to a user. The present paradigm of sharing plant gardening information is to provide a list of factors about a plant to consider. These may include issues such as plant watering, sun placement, time to plant and fertiliser and caring such as pruning. In FIG. 4, the label 499 is one example. The label contains water drainage information 400, as well as the amount of water to apply 402, the amount of sunlight 401, and care tasks that cannot be sensed by this proposed system but require regular attention, for example 403 “fertilize annually with slow release” as well as a plant name 405.

Referring to FIG. 4, Some of these activities involve remembering to do things such as watering as instructed by 402, while other involve additional skills in judgement and know-how which are not easily communicable and require real life experience to do for example Firstly, Understanding where the soil has good drainage as instructed by 400. Secondly, Determining whether the sunlight is sunny or partly sunny (which may also vary significantly according to geographic location to obtain optimum results) as instructed by 401. Thirdly, Remembering to fertilize annually and selecting a slow release fertiliser as instructed by 403.

For reference with FIG. 4,
400—label indicating “well drained soil”
401—label indicating “full sun”
402—label indicating “low water”
403—label including information about fertilising, “fertilise annually with slow release”
404—label backing which may be typically plastic.
405—plant name
499—typical plant care label

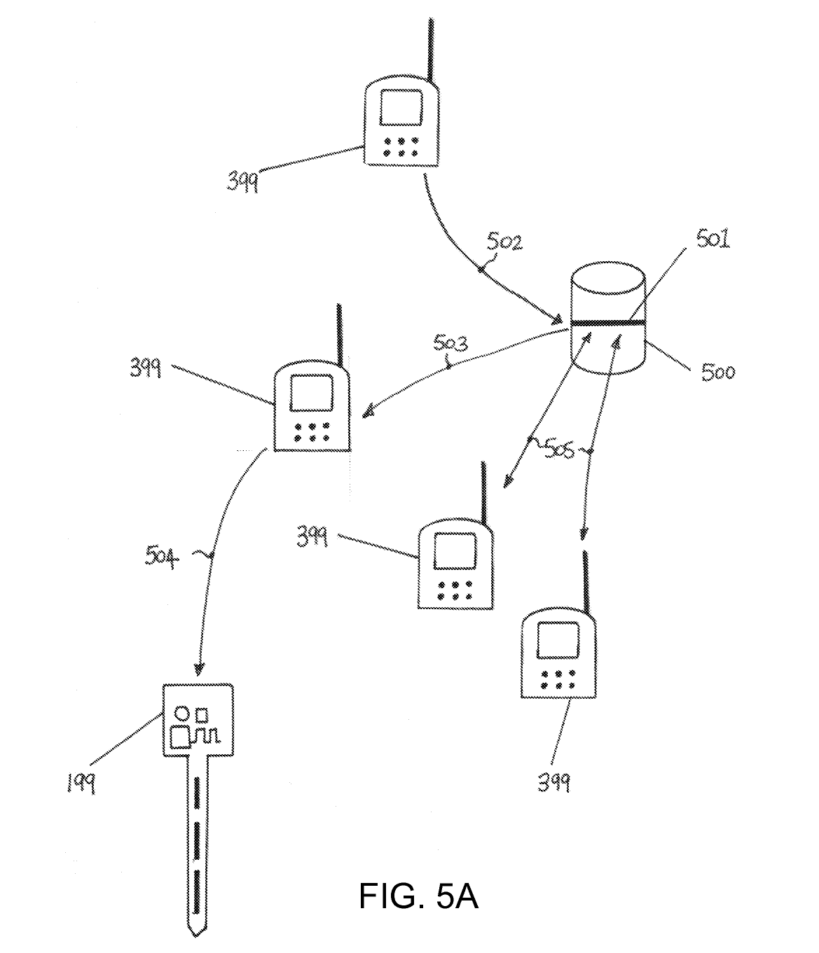

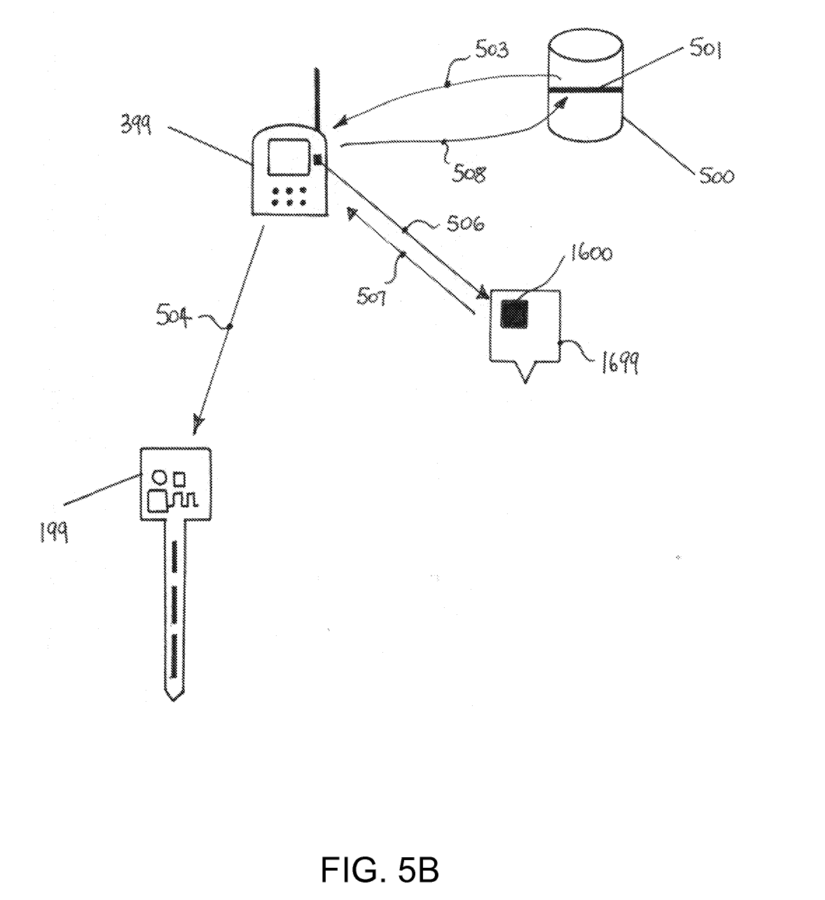

FIG. 5a depicts one embodiment of a system to share plant type profiles 501 by using creating and uploading 502 and downloading 503 as well as voting for them 505.

Referring to FIG. 5a, a device 399 may be used to generate a profile 501 which is then uploaded 502 to a remote server 500 to be shared. A second user may download the same profile 503 to their mobile computing device 399 and then download 504 to the plant sensor device 199.

Other users may also download, use, and also vote using the mobile computing device on the profile as well as adapt it and republish it.

Referring to FIG. 5A, The status of the plant is determine by taking the plant's current moisture measure from device 199 near the plant and performing a lookup of the plant type's moisture needs from the plant type profile 501 which has downloaded from remote server 500 or local database on the Mobile Computing Device or device 199, or a profile configured by the user on using the application software 302 on the Mobile Computing device 399. The age of the plant can be used by the profile to determine water and other needs due to the potential size of the plant. The plant sensor device 199 or Mobile Computing Device can take age and so size of the plant into account by obtaining the age, size and type of plant from the QR code 1600 or plant type from a normal bar code

One of three outcomes may result, Firstly, The plant is too wet for too long. If the moisture sensor 199 finds that for a time longer than acceptable for example many days or a week the absolute moisture value exceeds the profile range for the plant, then the user is alerted that the plant is consistently too wet. For example, the moisture range for the plant is 20% to 40% but the absolute value averages 80%. Secondly, The absolute moisture range percentage matches the preferred range so the user is not alerted. Thirdly, The soil is too dry for the plant. For example, the moisture range for the plant is 20% to 40% but the absolute value averages only 10%. The user is alerted to water the plant. Several plant type profiles can be associated with the same plant sensor device 199, For each plant the calculation is repeated and for any plant requiring watering or other attention an alert is generated.

In another embodiment, not just the moisture but all the other sensor values, temperature, light, humidity, air pressure 133, air flow including but not limited to a anemometer 127, pH, are checked in a similar manner against the profile and the user alert if any care actions are required by the user. The action to take may differ significantly depending on the property being measured, for example in the case of light the action may be to move the plant's location in order that if can receive more or less light. In the case of humidity being too low, it may be recommended to use a green house, in the case of airflow being too low then plants should be spaced with a large distance between them. In the case of pH low, Lime is applied to the soil of home lawns to increase the soil pH. In the case of temperature being too low for the plant it may be recommended to place the plant inside or in a green house.

FIG. 5b depicts one embodiment of a system where the user scans a bar or QR code which is used as an identification key to lookup the plant type profile which is downloaded.

Referring to FIG. 5b, a device 399 can use it's camera to scan a bar code, QR code, picture or text 1600. The information 507 from scan 506 can be used as a key or ID 508 to access a specified profile 501 which is returned 503 to the mobile computing device 399 and then downloaded 504 to the plant sensor device 199 from where the device can process the plant profile properties, rules and actions. In addition to scanning barcode, or QR codes, names can also be used to search databases of plant profiles.

For reference with FIG. 5,
501—Plant type profile
500—Database and server of plant type profiles, capable to also perform profile calculations as a server.
502—Shared, uploaded plant type profiles.
503—Downloaded plant type profiles.
504—Downloading of plant type profile to plant sensing device
505—User vote of plant type profile records, this can be used to develop a website of ranked by popularity plant profiles for use. The plant profiles can be provided free or require payment to download.
506—Scanning QR code, or bard code, 509 using camera for Mobile computing device 399 to plant type identifier for lookup of database 500 to find record 501.
507—Data returned from scanning QR or bar codes.
508—key or ID for identification of plant type profile for downloading.

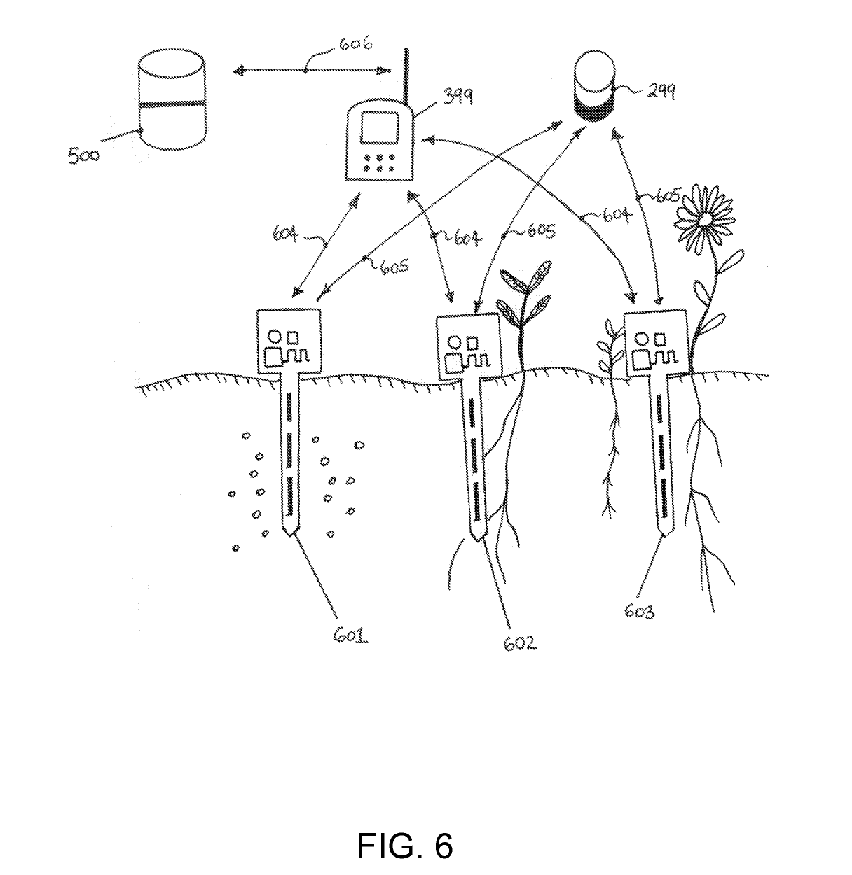

FIG. 6 depicts one embodiment of difference usage configurations for a plant sensor device including one where the plant sensor device is only checking the soil, one where it is monitoring only one plant and one where it is monitoring two plants and can adjust warnings by using the measured sensor values against each of the profiles to see if alerts for user care need to be generated. One plant sensor device 199 monitoring an area of soil is shown 601. one plant sensor device 199 monitoring on plant is shown in 602. One plant sensor device 199 monitoring multiple plants. The communication between the plant sensor device 199 and mobile computing device 399 using radio (such as Bluetooth 4) is shown as 604.

Referring to FIG. 6, during setup plants are associated with a plant sensor 199 in different ways. In a first way One device 199 is used to for monitoring each plant as per device 602. In a second way, One device 199 is used to monitor multiple plants as per 603. If the two plants have different water requirements the same sensor may deliver an alert to the user via the mobile computing device 399 or alert device 299 for one plant but not the other because their needs are different. In a third way a plant sensor device 199 measures the moisture in the soil from which all plants in the garden can use the value to match against their profile.

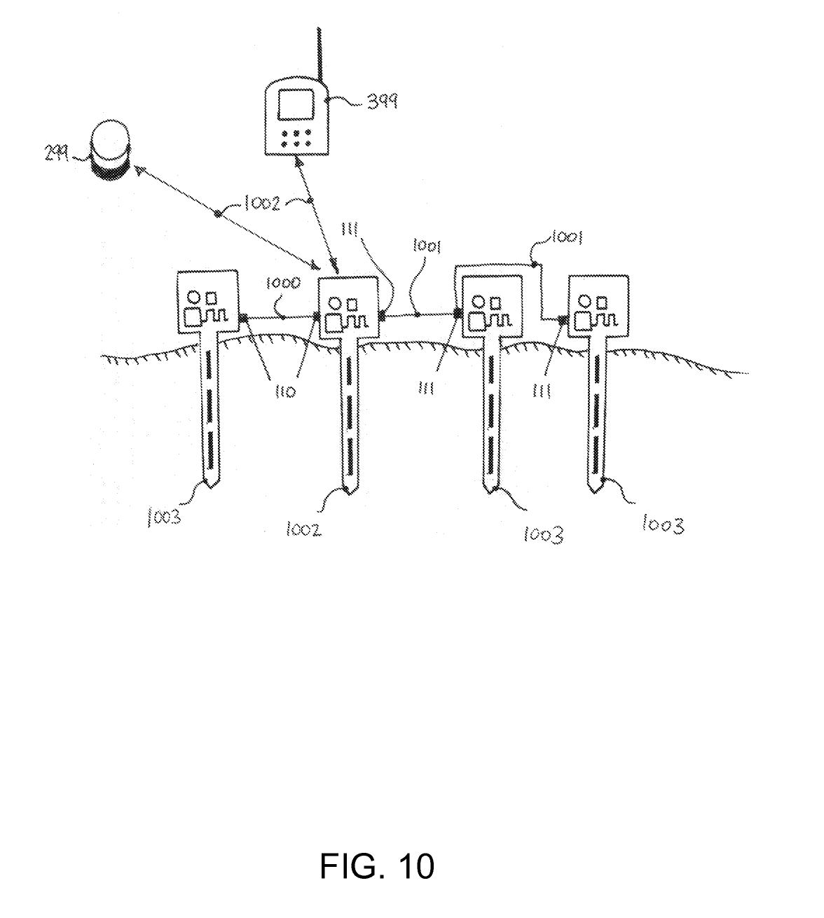

Referring to FIG. 6, it shows that the user may be alert and monitor via device 299 or 399. Plant type profile information is obtained from 500 via communication 606. One device 199 with Bluetooth capability has many wired connected slave 199 devices, by either the connection methods 110 or 111. Each slave device 199 monitors a plant or group of plants. FIG. 10 shows the one possible electrical connection topology.

For reference with FIG. 6,
601—one plant sensor device 199 monitoring an area of soil
602—one plant sensor device 199 monitoring on plant
603—one plant sensor device 199 monitoring multiple plants
604—communication between the plant sensor device 199 and mobile computing device 399 using radio (such as Bluetooth 4)
605—communication between the plant sensor device 199 and an alert device 299 using radio (such as Bluetooth 4)
606—communication between the mobile computing device 399 and 500.

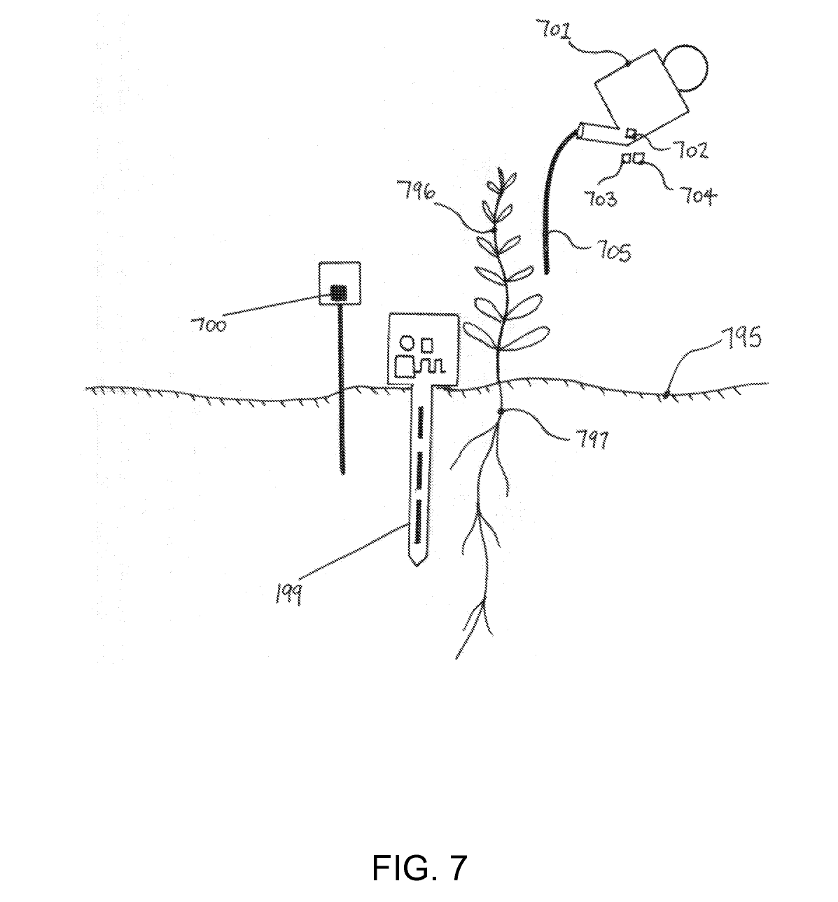

FIG. 7 depicts one embodiment of a configuration which can be used to indicate the amount of water applied and communicate this to the system. It also depicts a workflow to follow to measure the moisture transmission quality of the soil.

A QR code or bar code 700 can be used to lookup a plant profile. The configuration to demonstrate the determination of the amount of watering required comprises of watering device (such as sprinkler, house or watering can) 701, a water flow sensor 702, a processor 703 and software to measure and report to the mobile computing device 399 or plant sensor device 199 the amount of water poured from the watering can (as one example) to the plant and soil as measured by the water flow sensor 702. An antenna 704, plant above ground 796 and the plants roots below the ground 797.

Referring to FIG. 7, Water retention of the soil 795 and water flow (drainage) can be measured because the device 199 can be constructed with multiple levels through which over time the passage of water as indicated by changes in capacitance (or resistance) can be measured. In a diagnostic mode, the user may be asked to pour a known quantity of water 705 say, 1 Litre on the soil 795. A known quantity of water delivered for example as per FIG. 7 by a watering device such as watering can 701 which has been instrumented to record the amount of water delivered using sensor 702. The flow sensor 702 can report to the mobile computing device 399 when 1 Litre is reached or otherwise report flow so that the mobile computing device 399 can calculate and alert when 1 Litre has been delivered. Then the moisture content change with time and depth given by zones could be monitored to discover the flow root of water through the soil and root system 797 including the water collection at a depth in the soil which often may be undesirable as in the case of pot plants. This may be achieved by sensing the flow of water which is detected as the water enters higher zone and passes through as well as from taking reading at each level and recording the water that is constantly sitting at each level. Soil quality with regards to moisture trapping and transmission can be monitored and displayed to the user. Time based animation or graphs could be used. This may lead the user to change soil, aerate, change the concentration of organic matter, address soil aqua phobia. Optimal Watering frequency and quantity can be suggested to a user or automated irrigation system. Activities such as changing the construction of a plant's environments can also be suggested.

How much water 705 to apply can also be suggested to the user based on the needs of the plant as specified by the plant type profile and current moisture levels. Referring to FIG. 7, If a watering device such as watering can 701 fitted with a flow sensor 702, processor 703, and antenna 704 which can communicate using radio with the mobile computing device 399, has been used to water the plant previously so that the system can record the amount of water added to the soil and plant roots 797, and the moisture sensor device 199 measures the resulting moisture change and for how long the acceptable range was maintained, then over time the moisture device 199 can calculate how much water was added and for what percentage moisture adjustment resulted each time the moisture sensor. From this the system through the mobile computing device 399, moisture sensor 199, or water pouring device 701,702,703,704 can advise when the correct amount of water has been applied from either, firstly, a water devices 701, fitted with sensor 702, processor 703 and antenna 704 and display showing water poured on the mobile computing device 399 such as shown in FIG. 7 can be used accurately add the water required. When the correct amount of water 705 has been delivered as detected by the water flow device 702 the mobile computing device 399 can alert the user.

Secondly, The moisture sensor 199 can measure the moisture level in the upmost zone and indicate when the water applied there will be adequate when it dissipates into the soil over time.

For reference with FIG. 7,
700—QR code or bar code
701—watering device (such as sprinkler, hose or watering can)
702—water flow sensor
703—processor and software to measure and report to the mobile computing device 399 or plant sensor device 199 the amount of water poured from the watering can (as one example) to the plant and soil as measured by the water flow sensor 702.
704—antenna
705—water
795—soil
796—plant above the ground
797—plant roots below the ground

FIG. 8 depicts one embodiment of the application of the plant sensor device 199 to measure a pot to see if it is constantly wet at the bottom of the pot. The plant sensor device 199 has been placed in soil 800 which has a constantly wet zone 801 at the base of the pot 802.

For reference with FIG. 8,
800—soil
801—constantly wet soil
802—pot

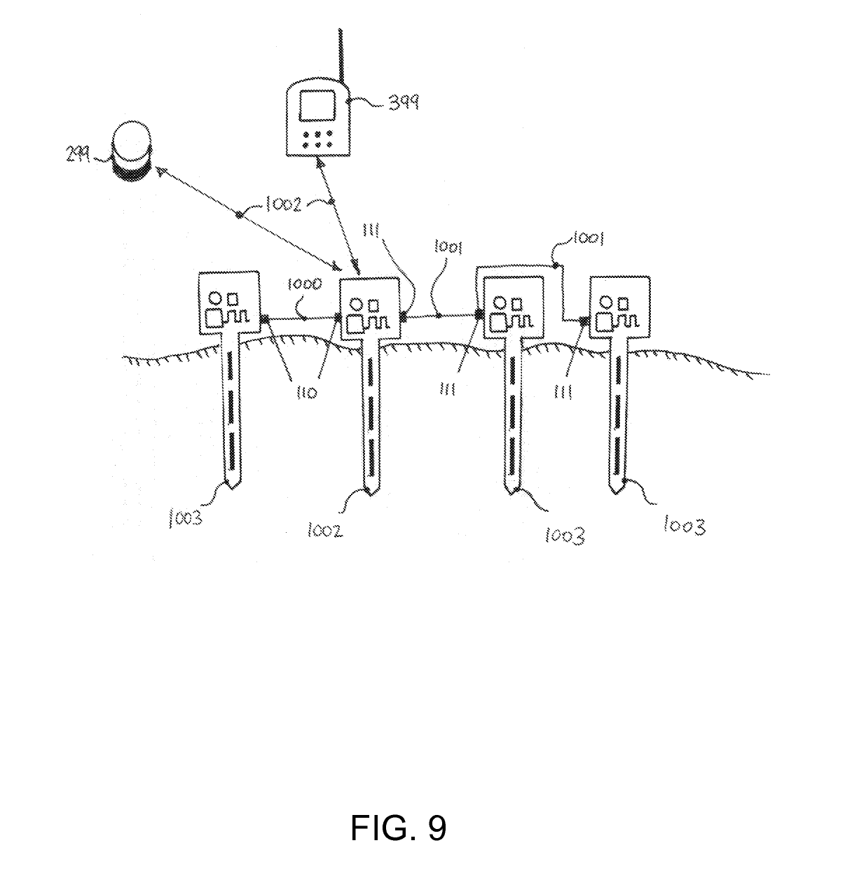

FIG. 9 depicts one embodiment of an example measurement by the system of moisture movement through the soil. Onto a garden bed 901 from a water container 701 containing a known quantity of water 912 from watering device 701 is poured into the soil 901 to be tested in the same location as a plant sensor device 199. The moisture sensors 131, 104, 116 and 117 are measured continuously with a set interval. In one example, at different time intervals “T0” 902, “T1” 903, “T2”, 904, “T3”, 905, “T4”, 906 the moisture is found to be at an overall peak at depths measured by moisture sensors 131, 104, 116 and 117 as the water seeps 913 into the soil. The peek itself reduces as the water dissipates widely as the water dissipates horizontally with depth in one example.

Referring to FIG. 9, At time “T0” 902, no water has been applied to the system. At “T1” 903 water, for example as mentioned above 1 L is poured on to the soil and detected by moisture sensor 131. At “T2” 904 the water is detected in the top soil zone of the sensor 104, By “T3” 905 some moisture is still present on sensor 104, but the middle zone soil moisture sensor 116 begins to measure moisture. By “T4” 906 some moisture is still present on moisture sensor 116, but the bottom root level sensor 117 begins to measure moisture. The depth at “T4” is 40 cm. At “T5” and “T6” time intervals up to “T8” well draining soil will see eventually demonstrate a fair to large proportion of the water no longer measured as it passes deeper into the ground beyond the roots of the plant at 50 cm by “T8”. The bottom of the soil where meets for example clay that stops further flow is marked 911 where the blocked water 914 accumulates at 50 cm

In other situations the moisture may remain at the root level measure by 117 and this may be detect and the user warned for example in the case of pots with poor drainage where diseases such as root rot may form.

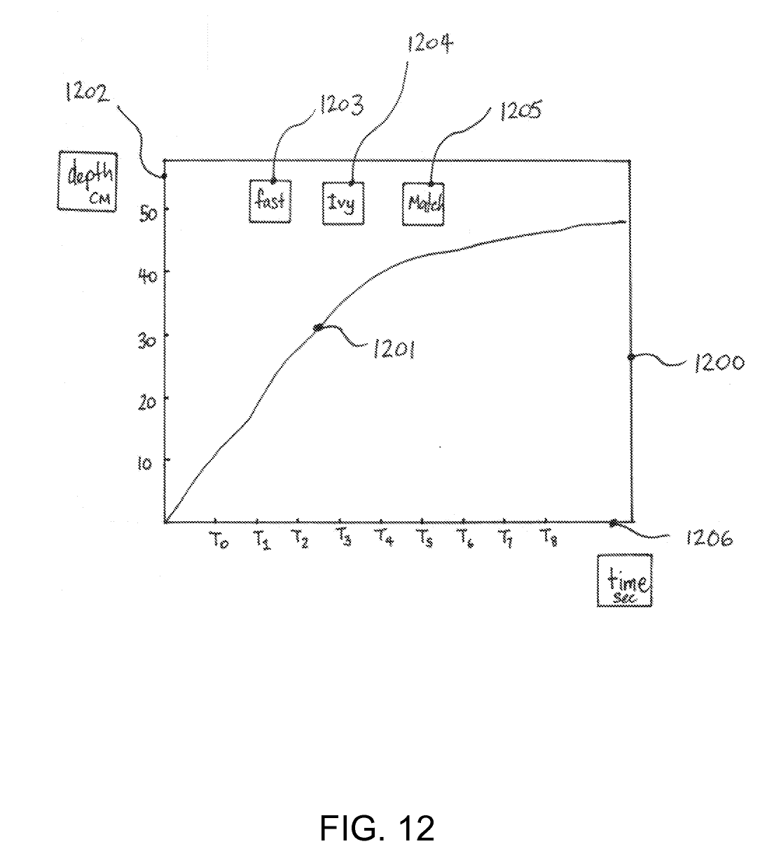

FIG. 12 shows a graph of the results for the analysis of following the action described in FIG. 9. When the soil test has been performed them the plant sensor device can use this information and with reference to the plant or plants that will be located at this position of measurement as defined by the profile suggest a type of soil and also additionally a brand as a form of advertising revenue creation. In one embodiment, this purchase suggestion would appear on the Mobile Computing Device. In another embodiment after performing the test described in FIG. 9, the user can then scan barcode and QR code on products in a shop, a lookup of the code to a database could retrieve to the application 302 running on the Mobile computing device characteristics of the soil to allow a check to see if the soil type scanned is appropriate. In this way a user can select the correct soil type when shopping. In this same manner the use can choose plants, fertilisers, nutrients and other products with cross reference to the plant profile(s) which are being shopped for. In one embodiment, the plant profile can specify the plant needs a soil type for moisture flow and containment that conforms to a standard such the John innes standards, JI seed, JI1, Ji2, JI3 and JI Ericaceous.

For reference with FIG. 9,
900—soil.
901—garden bed or water container carrying known quantity of water for example 1 L
902—Time “T0”
903—Time “T1”
904—Time “T2”
905—Time “T3”
906—Time “T4”
907—Time “T5”
908—Time “T6”
909—Time “T7”
910—Time “T8”
911—Bottom of soil where meets for example clay that stops further flow.
912—water poured onto the soil for test
913—water passing through the soil
914—water blocked by clay 911.

FIG. 10 depicts one embodiment of a plant sensor system that contains a multiplicity of a plant sensor devices 199 arranged without wireless but instead connected by wires using a protocol 1001 and without use of a protocol 1000 to a plant sensor device 199. Referring to FIG. 10, Two types of wire connectors can be used, one may simply use a digital analogue signals 1000 while others may use protocols 1001 which may provide configuration or advantages for communications over distance such as I2C© and 1-Wire©. The plant sensor device 1002 has a low power rf and 1 devices 1003 do not.

One advantage of such a configuration over the use of wireless plant devices 199 placed in the same positions each capable to communicate with device 299 or 399 is that the cost of manufacture of plant sensor device 199 will be less without the need for a expensive wireless processor and associated circuitry. For reference with FIG. 10,
1000—electrical connection
1001—protocol such as I2C
1002—plant sensor device of type 199 with low power rf. Such as Bluetooth 4 low energy
1003—plant sensor device of type 199 without low power rf.

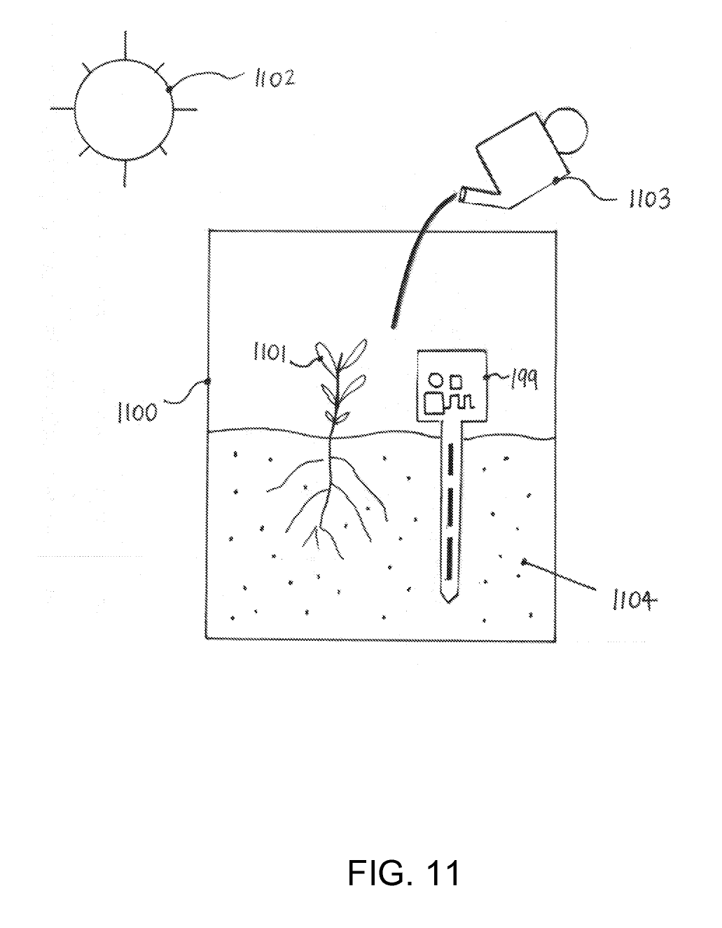

FIG. 11 depicts one embodiment of the plant sensor device 199 used in a or seed germination tray or other closed or semi closed system 1100 such as a terrarium or greenhouse to grow a plant 1101. The plant sensor provides a way to monitor and control this environment and customise the environment to grow particular plants for example a user in Norway could attempt to control the environment inside the closed or semi closed system to grow a pant which is normally only suited to Australia desert conditions. The measurement of the internal environment of system 1100 can allow the user to know when to adjust environmental factors such as sun and heat 1102, inputs such as water 1103 and the soil 1104.

Referring to FIG. 11, The plant sensor device by itself could be used to monitor a closed environment such as a terrarium 1100 where the environment inside the terrarium is monitored by the sensor and the user prompted to perform actions such as watering and altering the positioning of the terrarium in the sun to keep the system within bounds specified in a profile. The soil can also be measured to see that it has the same characteristics as those a plant likes such as in the case above Australian desert soil using a test method such as described n FIG. 9. The sensor can also detect the frequency of watering and that the soil does not stay moist as preferred by some desert plants.

For reference with FIG. 11,
1100—enclosure such as terrarium containing soil or other features.
1101—Plant to be monitored in the terrarium
1102—Environmental influences on the terrarium such as sun, but could also include heating device.
1103—Inputs to the terrarium which can be made by the user such as adding water to the system.
1104—soil in the system

FIG. 12 depicts one embodiment of a graphical display on the mobile computing device which shows the depth at which moisture is concentrated over time allowing the user to see the movement of water through the soil and determine if the flow rate is fast, media, slow, the soil water bound or too dry (indicating no water flow). The depth at which the moisture is concentrated can be calculated by locating the zone 104, 116 or 117 with the highest moisture reading. Where two zones have a proportion of the moisture the concentration can be found to be at a maximum at points between the two zones. The physical depth is calculated using information about the depth of each zone down the length of the probe section 132.

Referring to FIG. 12, it shows soil moisture flow graph 1200 showing the change in moisture concentration at depth over time. The line 1201 shows the change in moisture concentration depth over time where the moisture depth changes between 0 cm and 40 cm between time T0 and T4 and then slowly to 50 cm at T8. The depth axis 1202 for example in this case between 0 cm and 50 cm. Based on the slope of the graph 1201, a display element 1203 indicates if the flow Is slow, medium or fast. The display element 1204 Indicated which plant or plants profiles, if any, are assigned to this soil and the display element 1205 indicates if the plant or plants profiles assigned to the soil match the soil moisture holding and flow characteristics. For example, if the flow rate 1203 is well draining soil and the plant profile assigned to this soil is well drained.

As with all the sensor values measured by the plant sensor device 199 it communicates with the mobile computing device 399 using radio communication such as low power radio, and transfers the moisture at depth values which are displayed on the mobile computing device 399 screen.

For reference with FIG. 12,
1200—soil moisture flow graph showing the change in moisture concentration at depth over time.
1201—line showing the change in moisture concentration depth over time where the moisture depth changes between 0 cm and 40 cm between time T0 and T4.
1202—depth axis for example in this case between 0 cm and 50 cm.
1203—based on the rate of change indicates if the flow Is slow, medium or fast.
1204—Indicated which plant or plants profiles, if any, are assigned to this soil for example, Ivy
1205—indicates if the plant or plants profiles assigned to the soil match the soil moisture holding and flow characteristics. Ie the flow rate 1203 is well draining soil and the plant profile assigned to this soil is well drained.
1206—time axis t0 to t8 in seconds.

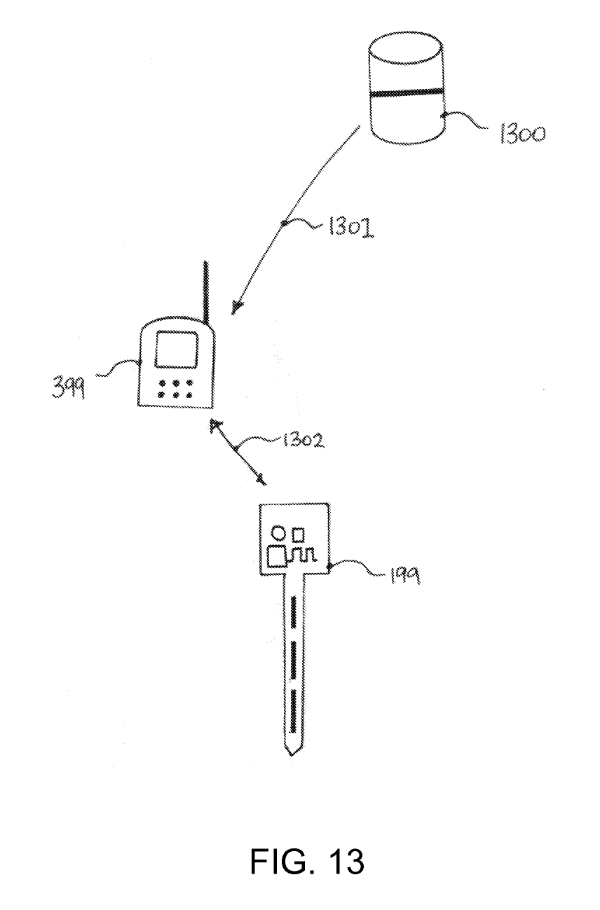

FIG. 13 depicts one embodiment of the Mobile Computing device 399 connecting to a remote server 1300 to receive weather data 1301 which is used to calculate when water and other care actions should be performed via an application 302 on 399 or in software in the plant sensor device 199.

As shown in FIG. 13, If the plant device can pair with an application 302 on the smartphone 399 and gain access to weather forecast services via web services 1301 from a remote server 1300, http requests, or other means it will attempt to cross reference this remotely acquired information against current moisture of the plant measured from the sensors on device 199, and the likely rate of change of loss of the moisture tomorrow and subsequent caused by for example heat or wind, If the plant will require watering sooner and if so alert the user via the phone. The application 302 will also contain a calendar of days that the user is not around may use this also to predict if more immediate watering will be required to keep the plant moist for example before the user goes away to anticipate a potential dry or wet weather event that may kill the plant. In one embodiment the weather data received 1301 as well as said user calendar data is passed 1302 to the plant sensor device 199.

For reference with FIG. 13,
1301—weather data
1300—remote server with weather data
1302—weather and calendar data

FIG. 14 depicts one embodiment of an automatic or manual watering system 1499 where a signal sent from a plant sensor device 199 or mobile computing device 399 or other computing device. The Automatic embodiment of the watering system 1499 comprises of processor 1400, antenna 1401, electrical connector between solenoid and processor 1402, valve 1403 which control water flow through the water pipe, solenoid opening and closing water valve 1404, power connector 1405, electrical control wire 1406, water pipe 1407, water to the plant 1408, software in the processor 1400 to control the turning on and off the solenoid in response to the message received by antenna 1401 or 1406 electrical connection 1409.

Referring to FIG. 14, shows a watering device than can be placed near a plant and deliver to that plant a configurable amount of water 1408 via piping 1407. The watering timing and quantity could be controlled by execution of rules according to a profile from a plant sensor device 199 or mobile computing device 399 and communicated by direct electrical connection 1406 or radio using antenna 1401 using also processor 1400 and receiving power from a battery or external source 1405. The solenoid 1404 controls valve opening 1403 and so the flow of water 1408 through the pipe. One example means of communication is via low power RF “Bluetooth 4” or other Radio or electrical connections.

In one alternative embodiment, in place of the processor 1400, antenna 1401, electrical connector 1402, solenoid 1404, power connector 1405 and electrical control wire 1406 and software 1409, the valve 1403 is manually set according to a range comprising of in one embodiment six increments graduating from off through to completely on. The application 302 uses the plant profile of the plant or plants near the watering device to tell the user which of the six settings to use. At set intervals a centralised water tank releases water into all connected pipes for a period of time. Sets of connected pipes can also be configured separately to have water released through them one at a time. Each time water is released into a set of connected pipes the system attempts to find the best balance between the amount of water to release, the length of time over which to do the release and the said value settings for each plant or set of plants in proximity to a watering device 1499.

For reference with FIG. 14,
1400—processor
1401—antenna
1402—electrical connector between solenoid and processor
1403—valve which control water flow through the water pipe
1404—solenoid opening and closing water valve
1405—power connector or battery, capacitor and or solar panel.
1406—electrical control wire
1407—water pipe
1408—water to the plant
1409—software in the processor 1400 to control the turning on and off the solenoid in response to the message received by antenna 1401 or electrical connection 1406
1499—Automatic or manual watering device.

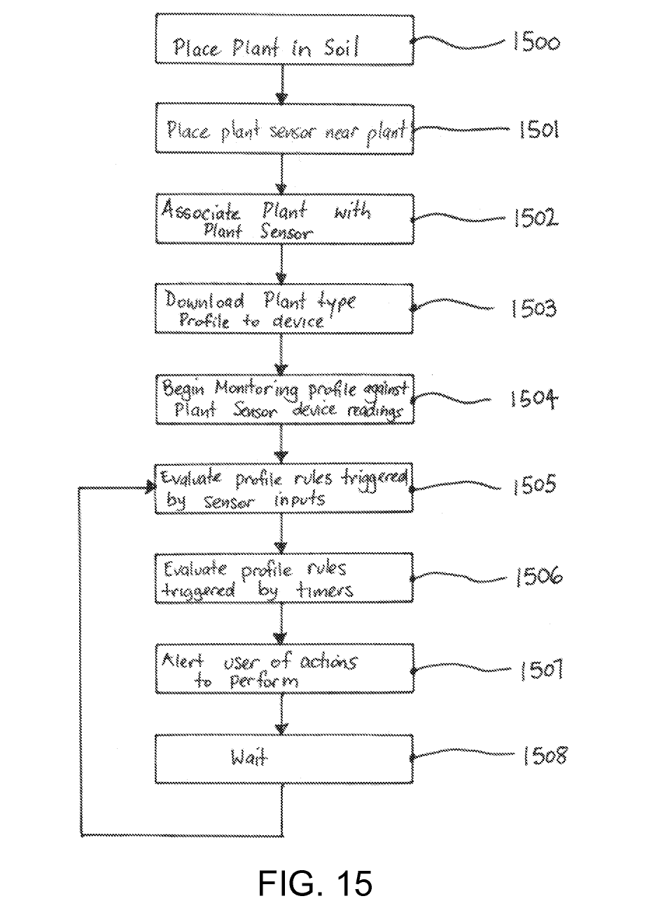

FIG. 15 depicts one embodiment of a flow chart of the setup and subsequent continuous monitoring of a plant or plants using, calculation and alert of user when

At 1500, the user places the plant in soil.

At 1501, the user places the plant sensor device 199 near said plant. Several plant types can also be associated with one plant sensor.

At 1502, the user associates the plant with the plant sensor device 199.

At 1503, the user and or the associated plant sensor device 199 downloads the plant type profile which has been associated by step 1502. The plant type profiles can be downloaded to the plant sensor device 199 or Mobile computing device 399 depending on where the calculations of the measurements compliance to the profile and actions to alert the user will be performed. If the calculations are to be done in the mobile computing device then sensor values are communicated from the sensor device 199 to the mobile computing device 399.

At 1504, the plant sensor device 199 reads the sensor values.

At 1505, software in the plant sensor device 199 or the mobile computing device 399 takes the readings and applies the rules in the plant type profile to determine actions to be alert the user to perform

At 1506, software in the plant sensor device 199 or the mobile computing device 399 takes the current time, or timers set to recheck rules, or timers set for seasons of the year, or days since germination of seed as a few non limiting examples of time related events and applies the rules in the plant type profile to determine actions to be alert the user to perform

At 1507, An alert is generated for user to take actions such as water the plant being monitored as the moisture value from the plant sensor device 199 is below the plant type's requirement in the plant type profile.

At 1508, a configurable wait is made before returning to step 1505 to repeat the process.

For reference with FIG. 15,
1500—place plant in soil.
1501—place plant sensor device near plant
1502—associate plant with plant sensor device.
1503—download profile for the plant type into the plant sensor device
1504—measure sensor values from the plant sensor device 199 near the plant.
1505—evaluate profile rules triggered by sensor inputs
1506—evaluate profile rules triggered by timers and time related events
1507—alert user of action to be performed based on evaluation 1505 and 1506.
1508—wait for variable amount of time, perhaps 1 hour, then return to 1504

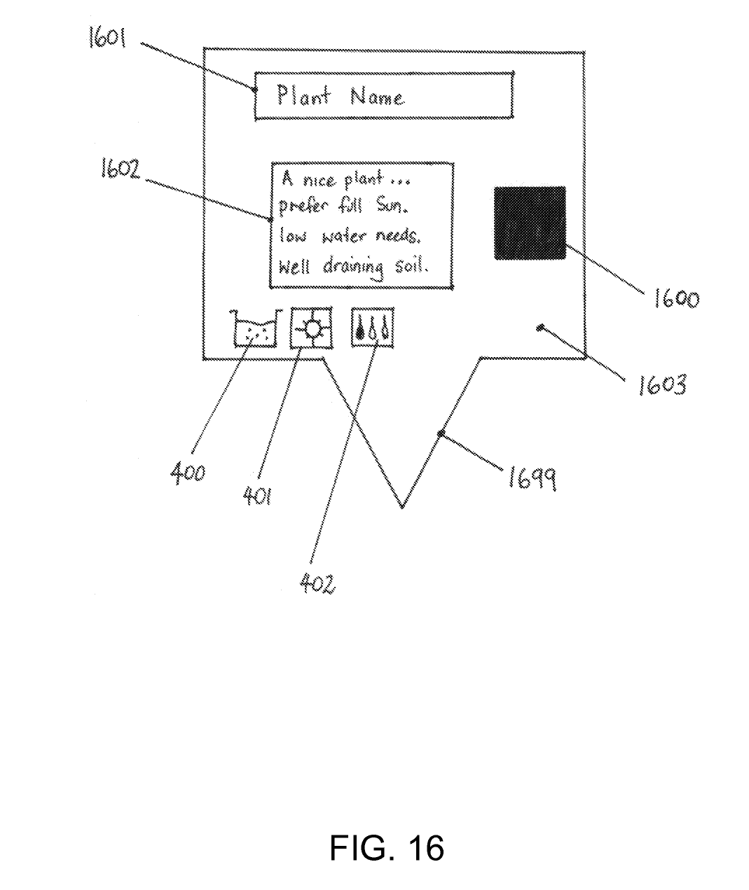

FIG. 16 depicts one embodiment of a plant care label 1699 with QR or barcode to allow scanning by a mobile computing device 399 to identify the plant type. FIG. 16 shows a label which may be placed with a plant in a pot. The label surface 1603 may be made of any material for example plastic. The label may contain the Plant Name 1601 for visual identification by a user, as well as a description of the plant how to care for it including environment preferences 1602 and a QR code or bar code 1600 which may be used to lookup on a remote server or a local database on the Mobile Computing device 399, the properties for care of the plant such as correct amounts of water, light and temperature needed as well as instructions for procedures to carry out on the plant at various times of year, such as moving the plant into more sunlight, or pruning. The QR code may also store some or all of this information internally. In order to lookup the plant properties, conditions and actions the Mobile Computing Device's 399 camera 306 scans the QR codes, bar code or performs text recognition software on the label information to determine information such as plant name in the application 302 to find the information and key to then lookup more information on a remote or local database.

One embodiment involves a label 1699 with a rigid backing 1603 with a printed plant name 1601, plant description and care instructions 1602 as well as a QR or barcode 1600.

FIG. 16 depicts various items which may be used to care for the plant including fertilisers, soil types each labelled with a QR code or bar code. The QR code can be read by the Mobile Computing Device 399 and Application 302 and checked for suitability for a plant under care or associated with the plant to indicate that it is being used with that plant and so taken into account in algorithms calculating the care of the plant.

For reference with FIG. 16,
1600—QR or barcode contain plant parameters and care information stored as properties, conditions and actions for stages of the plant or a key or code to reference said information from a remote server with the use of a QR reader application on a Mobile Computing Device 399. The QR code can also be customized with a unique identification code for each plant.
1601—printed plant name including optionally a picture.
1602—printed description of the plant including instructions for care and needs of plant.
1603—Rigid backing of the plant label. May be made from plastic.
1699—The entire label comprising of 1600, 1601, 1602 and 1603.

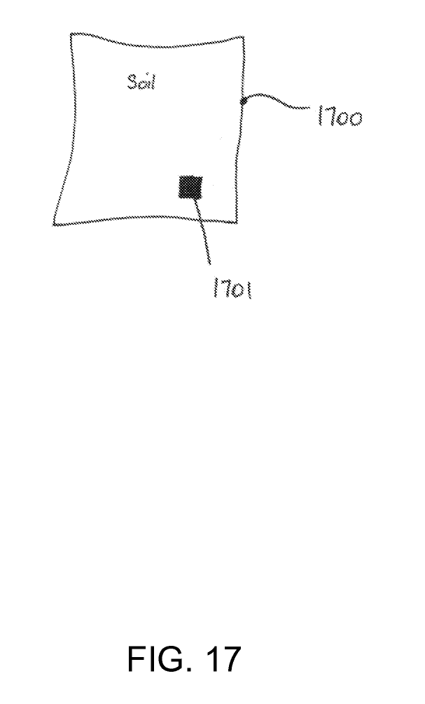

FIG. 17 depicts one embodiment of a packages that contains a multiplicity of a variable number of QR or barcodes on gardening soils, fertilisers and other items. The scanning of the code allows retrieval of data about characteristics of the item and suitability and effect of application to different plants. In one embodiment, Depending on the plant needs this data may indicate that the soil is suitable because it affords good drainage as required by the plant type or alternatively that changes need to be made.

For reference with FIG. 17,
1700—soil package, which may contain soil of different characteristics such as potting mix with course or finer particles, coded as defined according to industry standards John innes standards, JI seed, JI1, Ji2, JI3 and JI Ericaceous.
1701—QR code or barcode the scanning of which will provide data about the soil type to be read or a key provided to lookup up data about the soil type from a local or remote database. The data about the soil type indicating the properties of the soils that determine moisture movement and speed through the soil and moisture retention, as well as the compact ness of the soil, the nutrients in the soil and other characteristics.

FIG. 18 depicts one embodiment of a profile type profile or a succulent plant type. The profile comprises of a single or multiplicity of records. Each plant profile record has four fields, Stage, Property, Condition and Action as shown by the field headings 1800 separated by colons. Each record describes actions to perform when a given property matches a condition for a given stage of the plant's lifecycle. As an example, the first record 1801 comprises of an action “ask user to apply one quick drench of litre water” when the condition of moisture is less than 10% for the “plant” part of the lifecycle of a plant where the possible lifecycle states are “seed”, “seedling” or “plant”. The other record may be understood by reference to this explanation of this first record 1801. If the record is applicable for any stage in the lifecycle then the stage is marked as “any:” in the stage field of the record.

For reference with FIG. 18,
1800—Stage:Property:Condtion:Action
1801—Plant:Moisture:if no moisture (<10%): ask user to apply one quick drench of 1 litre water
1802—Plant:Moisture: If moisture (>70%): alert user that this is not ideal and the use should reduce watering.
1803—Plant:Temp:If temperature too low (<10 degrees):alert the user that this is not ideal for the plant.
1804—Plant:Sunlight:If light too low (<30%): alert user that not ideal for the plant
1805—Plant:Fertiliser:Every 4 months:prompt to user to apply fertilizer
1899—Profile for Succulent plant

FIG. 19 depicts one embodiment of a plant type profile for a strawberry plant. A plant type profile can comprise of a single or multiplicity of records. Each plant profile record has four fields, Stage, Property, Condition and Action as shown by the field headings 1900 separated by colons. Each record describes actions to perform when a given property matches a condition for a given stage of the plant's lifecycle. As an example, the first record 1901 comprises of an action “ask user to water” when the moisture is less than 50% for the “seed” part of the lifecycle of a plant where the possible lifecycle states are “seed”, “seedling” or “plant”. The other record may be understood by reference to this explanation of this first record 1901.

For reference with FIG. 19,
1900—headings for different parts of each rule Stage:Property:Condition:Action
1901—Seed:Moisture:If <50% moisture:ask alert user to water.
1902—Seed:Sun light:f<80% sunlight enough:ask user move plant into sun
1903—Seed:Temp:If too low (<20 degrees):ask the user to cover seed container.
1904—Seedling:Time (or user input indicating germination and growth to small plant):20 days following germination:Transplant seedling to separate locations in soil bed or pots
1905—Small Plant (seedling stage+20 days):Moisture:If <30% moisture:ask alert user to water.
1906—Small Plant (seedling stage+20 days):Temp:If too low (<10 degrees):ask the user to move into sun
1907—Small Plant (seedling stage+20 days):Sunlight:If <40% sunlight: move into sun
1908—Plant (small plant+20 days):Moisture:If wet (>70%) for 2 days or more:alert user suggest check drainage.
1909—Plant (small plant+40 days):Temp:If too low (<10 degrees):ask the user to move into sun
1910—Plant (small plant+40 days):Sunlight:If low (<40%) sunlight: move into sun
1999—profile for the strawberry plant

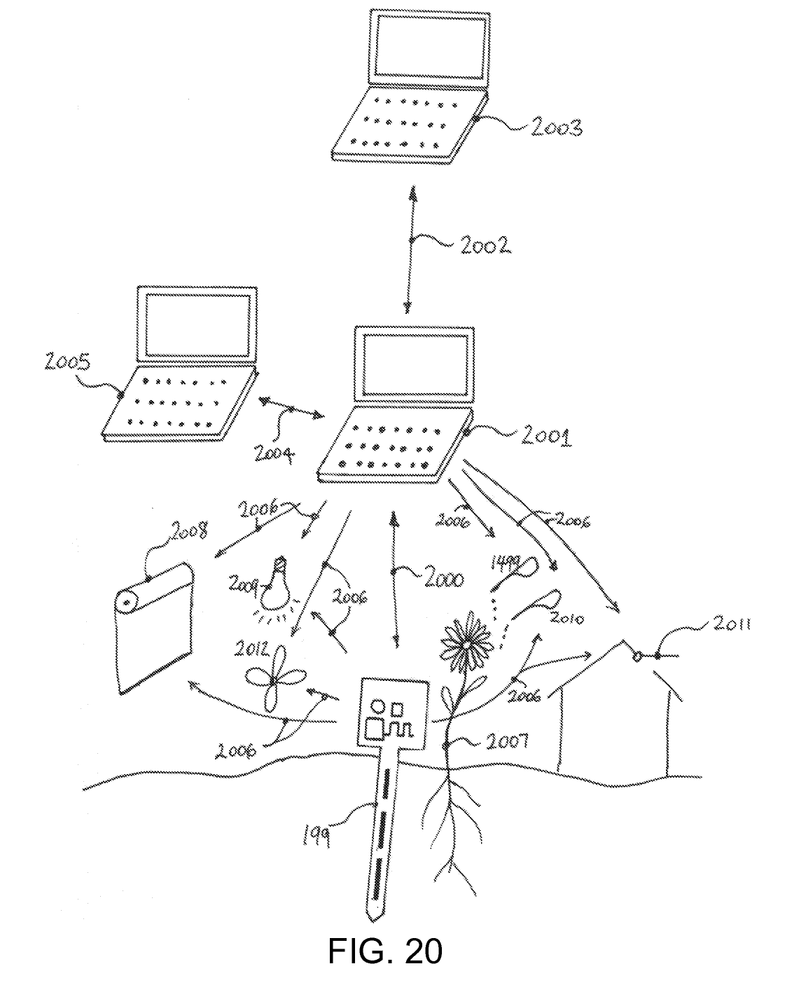

FIG. 20 depicts one embodiment of system allowing access to the plant sensor data, associated plant profiles and alerts for a plant sensor device 199 from all types of fixed and mobile computer devices in a local area accessible by a wifi or Bluetooth network as well as access to plant sensor data, associated plant profiles and alerts for a plant sensor device 199 from a remote location using protocols such as internet, 3G, 4G and all such communication protocols that allow the said information to be accessible remotely. The plant sensor device 199 can communicate using low power RF such as Bluetooth protocols 2000 with the computing device 2001 which can in turn communicate with other computing devices 2005 over a local network area using wifi and or internet protocols as some examples and with remote computing devices 2003 sending plant sensor information including associate profiles 2002 over an data connection such as internet on as one example, a mobile network, or other wireless network or fixed line copper, optical cable, coaxial or other types of connections. The computing device 2001 or a mobile computing device 399 or plant sensor device 199 can both send control data such as watering commands 2006 to devices such as watering controllers 1499 as other such environment controlling devices such as electronically controllable shade cloths 2008 or green house vent openings 2011 which can be extended or retracted to adjust the sunlight and temperature exposure of the plant as well as fertiliser injection systems 2010 into the watering supply for the plant or separately added as well as controllable heating sources 2009, controllable cooling devices 2012 as a few non limiting example of environment controlling devices to care for a plant under care 2007

In this system there may be one or more computing devices 2000, 2003 and 2005 as well as plant sensors 199 and controlling devices such as 1499.

Referring to FIG. 20, when the computer 2001 and 2005 are deployed locally they allow another means to access and process the information and in cases where a user may not have access to a mobile computing device or allow access using a network of other computers for many users to view the data such as may be helpful in a school settings for classroom use with many students. When the computer 2003 is deployed remotely this would allow as some examples but not limited to, a user monitoring, controlling, or receiving alerts while remote and on holidays, a neighbour watching plants, or a company providing a service to look after plants which would allow the company to minimise the number of visits to the a site to do watering, or allow them to request a local user to make some plant caring actions on their behalf.

One embodiment involves all the processing of the plant profile being done from a remote computer

For reference with FIG. 20,
2000—plant sensor device data and profile information
2001—computing device which can communicate with low power rf such as Bluetooth low energy and other protocols as well as internet over wifi, wireless and cable and mobile carriers as some non limiting example. The computing device can include laptop of desktop personal computer or virtual machine. May also be a mobile computing device
2002—plant sensor data, plant profile data and alerts
2003—remote computing device capable to communicate using the internet
2004—plant sensor data, plant profile data and alerts communicated by a local wifi, internet or Bluetooth
2005—remote computing device capable to communicate using local wifi, internet or Bluetooth
2006—control commands such as for watering and fertilizing, temperature control devices such fan and heater, shade cloths and greenhouse vents.
2007—plant under care
2008—shade cloth which can extend and retract a shading material such as woven plastic or cloth with the aid of a motor and which has a processor and antenna that can receive commands from a low power rf such Bluetooth low energy as one non limiting example.
2009—heating device which has a processor and antenna that can receive commands from a low power rf such Bluetooth low energy as one non limiting example.
2011—greenhouse vent that can open and close with the aid of a motor and which has a processor and antenna that can receive commands from a low power rf such Bluetooth low energy as one non limiting example.
2010—fertilizer dispending that adds to water or directly waters fertilizer onto plant or dispenses in dry form which has a processor and antenna that can receive commands from a low power rf such Bluetooth low energy as one non limiting example.
2012—fan cooler which has a processor and antenna that can receive commands from a low power rf such Bluetooth low energy as one non limiting example.

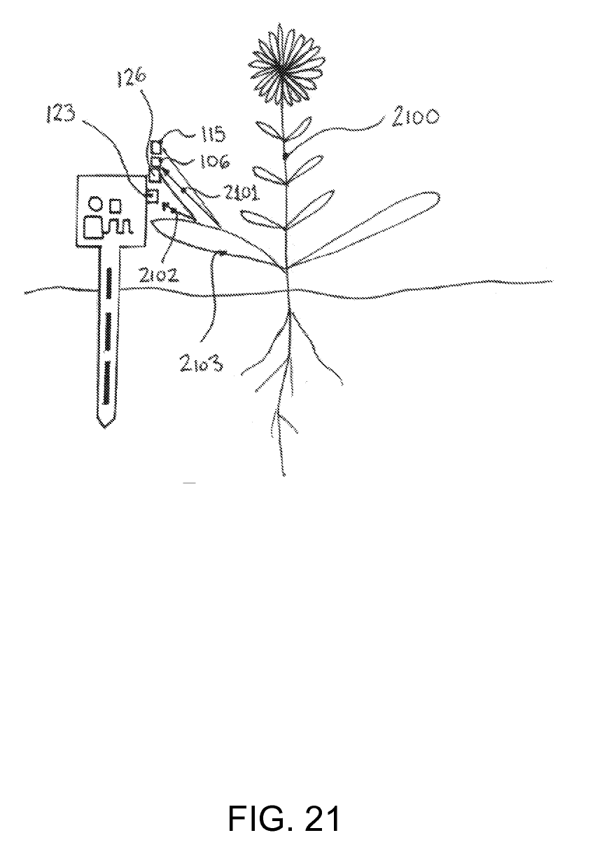

FIG. 21 depicts one embodiment of a setup to measure the reflective response of the leaf 2103 on a plant 2100 to a visible light source 115, near-infrared and infrared light source 126 by a visible sensor 106 and infrared and near infrared sensor 123 mounted on the device 199. The measured reflected visible light 2101 and infrared and near-infrared light 2102 is shown.

Referring to FIG. 21, the health of the plant in terms of chlorophyll and water absorption can be determined by the percentage reflection of light of visible, near—infrared and infrared light.

For reference with FIG. 21,
2100—plant which is having its health assessed
2101—visible light reflected from leaf which can be used to determine health of chlorophyll levels
2102—near infrared and infrared light reflected from the leaf which can be used to determine water absorption.
2103—leaf from which reflection measurements are being made.

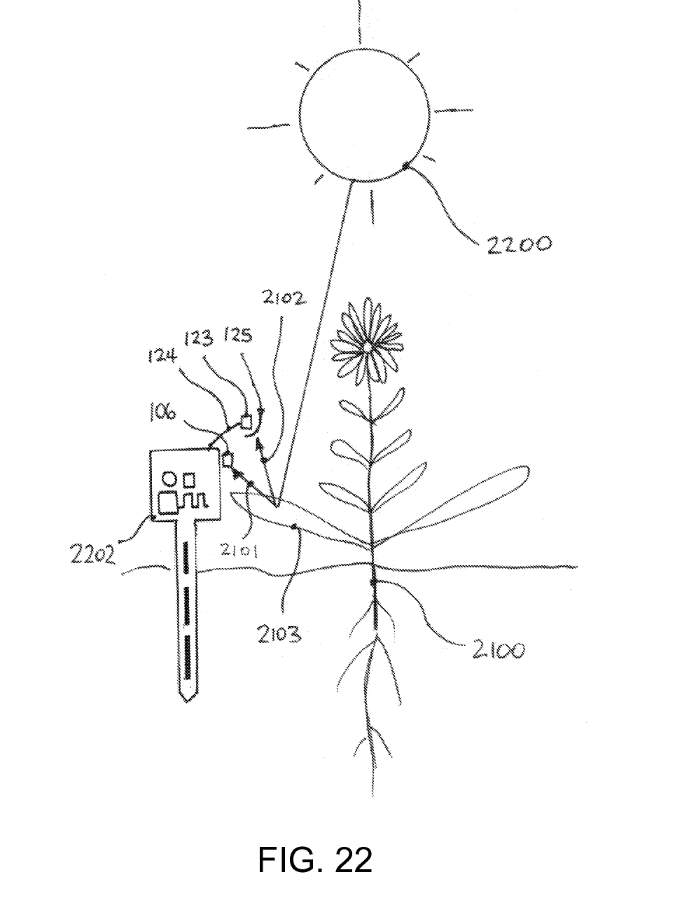

FIG. 22 depicts one embodiment of a setup to measure the reflective response of the leaf 2103 on a plant 2100 to a visible, near-infrared and infrared light source being the sun 2200 by a visible sensor 106 and infrared and near infrared sensor 123 connected by 124 with an optional lens 125 to allow a wide angle capture of light for measurement. The measured reflected visible light 2101 and infrared and near-infrared light 2102 is shown. The plant sensor device 2202 of type 199.

Referring to FIG. 22, the health of the plant in terms of chlorophyll and water absorption can be determined by the percentage reflection of light of visible, near—infrared and infrared light measured using the sun 2200 as the light source with a plant sensor device 2202

For reference with FIG. 22,
2200—sun source of visible, infrared and near-infrared light
2202—plant sensor device of type 199

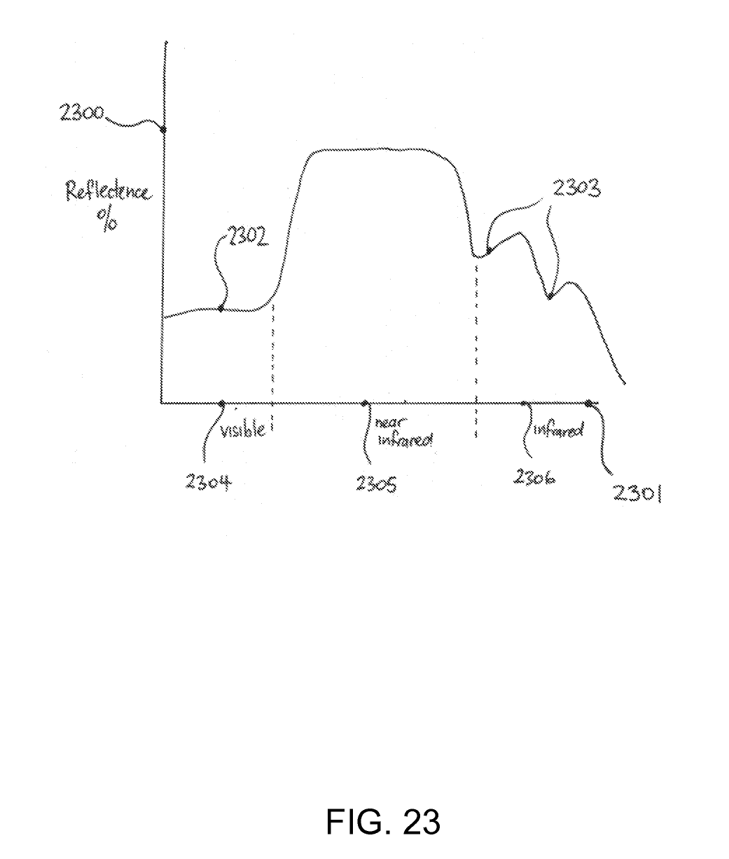

FIG. 23 depicts one embodiment of a graph of one example of a reflection response of a plant leaf and foliage to visible, near-infrared and infrared light. The graph has a vertical axis showing the percentage reflection 2300 and a horizontal axis showing different light spectrums from visible to near infra-red to infrared 2301. The percentage reflection for visible light determines the chlorophyll absorption 2302 and water absorption 2303. The configurations on FIG. 21 and FIG. 22 can be used to make these measurements.

Referring to FIG. 23, the health of a plant can be determined by measuring how it reflects light. For example, a plant with leaves with healthy chlorophyll levels will reflect less visible light and reflect more near infra-red. Healthy levels of water absorption can be determined by the reflectance of the plant's leaves of shortwave infrared. Analysis of a plants spectrum of absorption and reflection in the visible and in infrared wavelength is very useful in providing data about a plants health. Each plant type has unique patterns and ranges for reflectance and healthy variations in these patterns. The differential between the ambient air temperature and leaf temperature is an indicator of plant stress.

For reference with FIG. 23,
2300—percentage reflection vertical graph axis
2301—horizontal axis, light spectrum, visible, near infra-red and infrared.
2302—percentage reflection due to chlorophyll health.
2303—percentage reflection due to water reflection
2304—measured visible light
2305—measure near infrared
2306—measured infrared

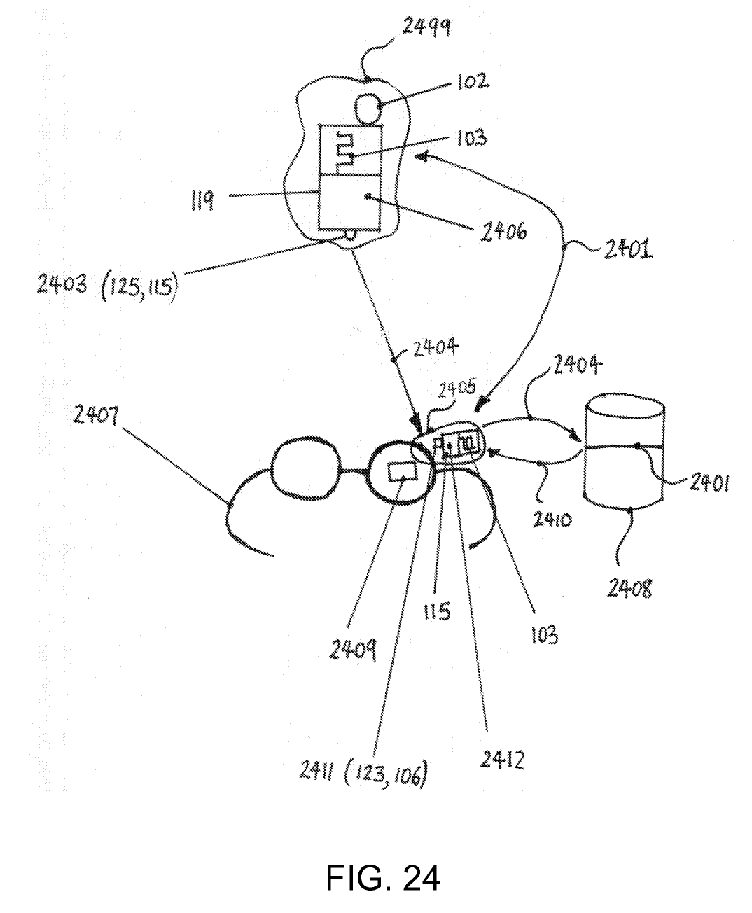

FIG. 24 depicts one embodiment of a system where a plant sensor or retail device can transmit a code to be detected by “google glass” or similar devices causing the display of product information on “google glass”.

Referring to FIG. 24, a plant or retail device 2499 has software 2406 that generates a identification code 2404 using emitters 2403 that is received by “google glass” device 2407 containing the functionality 2405, including 2411, that when it receives the identification code 2404, software 2412 performs a lookup on a database 2408 retrieving product or plant information 2401 sent 2410 to 2499 where it is displayed on 2409.

For reference with FIG. 24,
2401—product information images, video, text, audio as well as plant information
2403—emitters infrared 125 or visible light 115
2404—identification code for looking up plant sensor or product information
2405—functionality including a processor and lower power rf capable of Bluetooth, Bluetooth low energy and infrared sensor, camera, and video camera which may or may not be already built into google glass. Also including software to decode codes 2404 and send to database 2408 and receive and display images, text, audio and video information 2409.
2406—software communicating plant sensor identification and retail identification and data
2407—device such as “google glass”.
2408—database of images, text, audio and video information
2409—Display surface for display from inside “google glass” for user viewing
2410—images, text, audio and video information corresponding to the identification code 2404 sent for display to user on 2409
2411—camera or video camera, optionally capable of infrared detection as well as infra red and or visible light sensor.
2412—software that reads the identification code 2404, sends requests with the Id 2404 to 2408 to retrieve and display video, audio, data, text and images on 2409 or retrieves this data, display video, audio, data, text and images from 2499.
2499—Plant sensor device 199 or retail device using subset of 199 with optional inclusion of 2406, 119,103,102,125,115 and 101

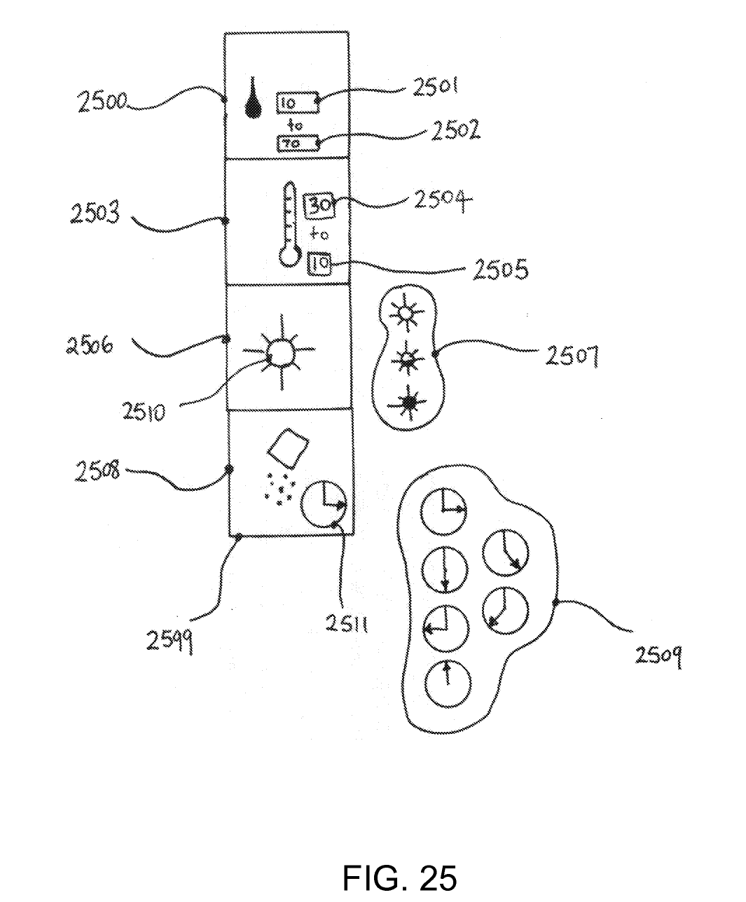

FIG. 25 depicts one embodiment of a graphical based system for defining a plant profile as an alternative to code based approach. Settings can be made for properties such as, but not limited to Moisture/Watering needs, Ideal Temperature and Sunlight for the plant as well as reminders for fertilising can be configured by selecting symbols representing the properties and Conditions required. The symbols can be displayed to the user as actions when the conditions are no longer correct so that the user can easily recognise the property requiring attention. Specification of the plant profile in this format is has an advantage in being closer to the current way that plant care is communicated on existing labelling as shown in FIG. 16 making it more familiar and therefore easier for users to understand and configure.

This is one alternative way of defining a profile however any techniques well known to graphical or user interface design where inputs are taken from the user to create a definitions file or configuration file can be employed.

Referring to FIG. 25, a graphical based system for defining a plant profile is depicted as an alternative to a code based approach plant profile depicted in FIG. 18. The same properties as in FIG. 18, moisture, Temperature, Sunlight and Fertilizer are being monitored but instead of a text based approach to choosing the properties to be monitored symbols are chosen by the user for the properties. Then in turn, for each symbol the conditions are configured. For moisture 2500, the percentage range of moisture is specified as 10 percent 2501, to 70 percent 2502. For temperature 2503, the temperature range is specified as 30 degrees 2504, to 10 degrees 2505. For sunlight 2506 a choice of full shade or partial sun or full sun is given by interface and the user chooses one of these three symbols 2507, in this case full sun has been chosen as depicted by 2510. For Fertilizing 2508 the frequency of fertilization is configured by selecting a time symbol representing how often within a year the fertilizing is repeated. The symbol for frequency employed appears as a clock dial where, when the hand is at 12 o'clock this represents yearly, the hand at 3 o'clock represents quarter yearly, the hand at 6 o'clock represents half yearly, and so forth. Different frequency symbols 2509 can be selected by the user. In 2508, the quarter yearly symbol 2511 has been chosen. When a property 2500, 2503, 2506, 2508 is out of range, then the user can be presented with a flashing or red colored version of the symbol and or the range value which is above or below the required value so that he understands the action required. In the case of fertilizing the expiry of a timer is the trigger rather than a sensor value.

Further alternatives for user interface variations may involve the use of slider controls for value range selection which could be used to replace the edit boxes 2501 and 2502 in the case of the moisture selection with either two sliders for the upper and lower limit or one slider with a configurable range where that range can be adjusted in range and then the range itself selected and slid up and down the full range of values. All other types of graphical elements known to user interface design may also be used. The graphical definition can be converted by the symbol to a code based equivalent specification and stored as such in one embodiment.

For reference with FIG. 25,
2500—plant/soil moisture property represented by droplet and percentage moisture range defined between an upper value 2501 and lower value 2502. In one example the moisture is shown to be configured to be needed to be in the range of 10 percent 2501 to 70 percent 2502.
2501—User interface edit box where the user can enter a percentage for moisture. In this case the upper percentage value
2502—User interface edit box where the user can enter a percentage for moisture. In this case the lower percentage value
2503—Temperature property configured by the user setting an upper temperature of 30 degrees temperature 2504 and a lower temperature value of 10 degrees 2505.
2504—User interface edit box setting an upper temperature of 30 degrees temperature.
2505—User interface edit box setting an lower temperature of 10 degrees temperature.
2506—Sunlight property for sunlight experienced by the plant. Set to full sun 2510 from possible setting 2507
2507—symbols representing a range of possible sun light settings, shade, partial sun and full sun.
2508—Fertilizing frequency setting where quarter yearly has been chosen 2511 from a range of possible time periods 2509
2509—A range Time frequency symbols from quarter to one year.
2510—full sun symbol to indicate the plant prefers full sin chosen from the choices 2507
2511—Quarter yearly frequency chosen for fertilizing
2599—Graphical format for configuring a plant profile.
   In some embodiments, the properties, conditions and actions described are non limiting examples. The system is capable to deal with any number of potential properties, conditions and actions for which the system has been described to be flexible to support.

In one embodiment, the plant sensor device 199 may possess all properties and rules comprising of conditions and actions or instructions for stages of the plant's lifecycle as specified by a plant type profile 501, and the sensor's processor performs calculations and generate an alert from the device including audio, visual or communicates an alert to another device such as the Mobile Computing Device by wireless transmission. The plant sensor device 199 may be configured with properties and rules comprising of conditions and actions or instructions by the mobile computing device 399.

In one embodiment, the Mobile Computing device 399 may possess all properties and rules comprising of conditions and actions or instructions for stages of the plant as specified by a plant type profile 501, and the Mobile Computing device's processor performs calculations and generate an alert from the device including audio, visual or communicates an alert to another device such as the remote server 500 or device 299 by wireless transmission. The Mobile computing device receives sensor values from the plant sensor device 199 via a low power rf link such as Bluetooth low energy. The plant sensor device 199 may be configured with properties, rules comprising of conditions and actions or instructions for stages of the plant lifecycle by the remote server 399.

In one embodiment, the remote server 500 may possess all properties and rules comprising of conditions and actions or instructions for stages of the plant lifecycle as specified by a plant type profile 501, and the remote server's processor performs calculations and generate which may be pushed to the mobile computing devices which can generate an alerts including audio, visual or communicates an alert to another device such as other Mobile Computing Devices and device 299 by wireless transmission. The remote server receives sensor values from the plant sensor device 199 via a mobile computing device 399 which in turn has received its sensor values from a plant sensor device 199 via a low power rf link such as Bluetooth low energy The remote server 399 may be configured with properties, rules comprising of conditions actions or instructions by the mobile computing device 399 or other computing devices.

In one embodiment, where Mobile Computing Devices 399 are mentioned throughout this document, the laptop computers and tablets could also be used to perform the same task.

In one embodiment, the user associates a plant sensor device 199 with multiple plants of a multiplicity of types at the same time. The user chooses plant types from a list on the mobile computing device 399 for all the plants that he wishes to receive updates about which are located near the sensor 199 and then associates them with the plant sensor 199 which either the mobile computing device is currently paired with or from a list of plant sensor devices 199. To make the association easier each plant device sensor 199 can be identified by a label 118.

In one embodiment, If a QR or bar code 1600 has been created or exists on a label next to the plant, then the instead of selecting the plant type from a list on the mobile computing device 399, scanning the QR code can cause the selection. The QR code can hold some or all of the information about the properties and rules comprising of conditions and actions or instructions to be used as a lookup for all the information on a local database on the mobile computing device 399 or a remote database on a remote server 500.

The QR code 1600 can be used to lookup all the information that is common to all plants of this type in a local of remote database with specific information such as the exact age of the plant, and location where the plant was purchased stored in the QR code.

In one embodiment, when the user requests an update on the plant status initiated from the mobile computing device 399, or comes in range of the plant sensor device 199 the status of all plants associated with that sensor is displayed on the mobile computing device 399. Alternatively if an identification ID is stored in the QR code 1600 then the user can scan the QR code will retrieve the plant status for that specific plant.

In one embodiment, the plant sensor 199 can be hold all the properties for each plant type that needs to be monitored and when any properties according to the stage of the plant are found to be out of range with sensed values or time has expired the an action is triggered. When an action is triggered the plant sensor device 199 attempts to connect to the mobile computing device 399 or advertises itself by transmitting a name or identification on the low power rf connection or in other ways makes itself visible to the mobile computing device 399 so that the mobile computing device can then connect and receive or in other ways receive the alert and data and inform the user. For properties that do not need to be sensed, for example are triggered by time, the mobile computing device can directly alert the user. For example pruning is carried out at the same time each year. The Mobile Computing device 399 can determine the time of year and see that the user needs to be alerted to prune with need for a measurement from plant sensor 199

In one embodiment, when a plant is located between one or more plant sensor devices 199, then the user can associate the distance and compass angle direction to each sensor as well as the plant sensor device ID 118 of each plant sensor and then the plant sensor device 199 associated with the plant will communicate with the other said associated nearby plant sensor devices 199 and calculate using algorithms the relative proportion of each sensor value to contribute to the calculation of the overall value for that plant. One example algorithm would take the average of the value, or worst case value depending on the values type, for example for moisture the driest value. Other algorithms employing methods that take into account the distances and directions could also be used such as calculations using centroids.

In one embodiment, a profile can be created with information such as properties, rules and actions for stages of a plants lifecycle as well as times of year, time intervals and sensed values from the environment of the plant.

Creating a profile for a plant builds a set of rules that can become the focal point for discussion and sharing, voting. The profile embodies a set of rules with associated actions such as alerting the user if watering is required. Once these rules are defined then combined with a device that can take measurements such as the plant sensor device 199, which checks against these profile rules this system that can transform expert advice, distilled into a shareable and downloadable profile and allow the user how to apply this advice to manage the plant without the user needing to remember to care for the plant, or the user being particularly skilled with plant growing and assisting when the user forgets.

The plant profile enables a sharing mechanism which takes the advice of experts through to hobbyists and automates the application of this expert knowledge to the care of a plant. The outcomes of the process may include requests to the user displayed to the user on a mobile computing device 399 to water the plant, commands to an automatic watering device, requesting the user to move a plant into shade, check and correct PH, apply fertiliser or choose the next plant to grow after this plant's season finishes.

One of the roles of the profile is to alert timely advice on activities that need to be undertaken at various times. If the user forgets to check the plant then for many activities the application 302 can remind the user by checking against the plant profile. The application can also make this check as background task. If the device 199 is within range of the mobile computing device 399 and a sensed value such as moisture needs action such as watering an alert can be sent to the mobile computing device 399 and the user can be reminded in this way. Also timing based reminders, such as “fertilise after 40 days” can be set in the application 302 on the mobile computing device 399 to trigger reminders.

The profile may use events such as time, or sensor measurements from 199 not limited to moisture, temperature and light which the processor in the device 199 or application 302 compares against and uses as triggers to consult the profile for the plant type resulting in the generation of “dynamic instructions” for the user to follow.

An example of a “dynamic instruction” would be a watering instruction. The instruction is dynamic in the sense that it is generated on a needs basis “dynamically”. When the plant sensor 199 detects that the moisture level in the soil has a percentage value less than the ideal moisture level range for the plant type then a “dynamic instruction” to water the plant can be generated. This “dynamic instruction” to the user is determined by evaluation of conditions and life stage of a plant for one or more properties when conditions trigger actions which become a “dynamic instruction” to the user. FIG. 18 and FIG. 19 show some example of these profiles. The system uses the ever changing sensor data from the plant sensor device 199 as input to activate the “dynamic instruction” when required. The plant sensor device 199 can receive a signal from the mobile computing device 399 when a user responds to an instruction by acknowledging that he has seen the instruction or has done the action requested such as watering the plant or moving it into the shade. When the plant sensor device 199 cannot contact the mobile computing device 399 or there is no signal indicating that the user has responded to the instruction, the system either from remote server 500 or the application on the mobile computing device 399, or the plant sensor device 199 predicts when a possible action might have been needed, and performs that event.

In one embodiment, if the user's mobile computing device 399 is not in range it will keep trying in case the phone comes into range.

In one embodiment, a indicator such as a LED or audible can also be used on the plant sensing device to allow another opportunity if they are in the garden to remember to check the plant.

In one embodiment, If there are multiple care person(s) for a plant then these can all receive measurement alerts as well as alerts from a remote server. Examples of multiple care person(s) may be in the case of a children's garden where the child is in charge of the garden but the parent can also receive alerts on their mobile computing device 399 in case the child forgets or doesn't perform a garden caring activity correctly. Office plants are often maintained by one employee who always remembers to water. When the employee is away then the plant is not cared for. In an office allowing multiple users to monitor a plant and reduce the chance of the plant missing to be care is reduced. In this case the profile is also of advantage because it allows less experience plant care person(s) to undertake task such as watering where the system tells them how much to water using the FIG. 2. If finally no local office staff respond then a remote plant monitoring company may receive an alert to attend to the plant as shown in FIG. 20 via 2001, 2002 and remote server 2003 which the plant company may have access to. The fact that the sensor can connect or “pair” in this way with multiple user's applications including also a plant company if for example everyone else forgets or the profile for the plant is not followed well creates a unique multiple care person(s) architecture which creates redundancy if a care person(s) forgets. It is contemplated that the care person(s) who most tends to the plant which can be sensed as they interact with the device may also receive points or rewards virtual or real. A of family several people may also share caring responsibility.

In one embodiment, the infra-red emitter 126 or visible light emitter 115, can transmit an identification code at any time or specifically when the user's mobile computing device 399, which includes devices such as Google Glass© come into range as indicated by a RF signal from the “google glass” using as one example lower power RF such as Bluetooth or Bluetooth low energy or the “google glass” emits an infrared signal. The identification code represents the plant sensor device. The said emitters are directional so that they are only detectable as the “google glass” wearing looks directly (with some angular tolerance) at the emitters mounted on the plant sensor device. The identification code comprises of a few known starting and ending pulses between which there is a set time interval divided into eight sub time intervals for eight bits in possible implementation. A code can be communicated by either emitting light or not emitting during each of the eight sub time intervals for the 8 bits. Other known transmission protocols can also be used. The “google glass” or similar device uses its video camera or camera to monitor for emitters patterns as described and if they are detected decode the identification for the plant sensor device which the wearer will be looking at in order to be able to see the code as the emitters as described are highly directional. When the “google glass” device has detected the identification code, it will show to the user on its display the plant sensor's location which should be approximately straight in front of the “google glass” at some distance, and then either connect to the sensor and retrieve plant information and display it or connect to a remote server and retrieve this information using the identification code. In other variations on the design, more or less than eight bits can be used. Those skilled in the art will understand that the methods used for transmission and reception of the visible or infrared light are known and used devices such as TV remotes.

The number of bits can be varied and some bits can be used to indicate status for example one bit could be used to indicate whether the sensor being looked at has actions that the user needs to carry out.

To limit the size of the identification code, the code may only be valid for gps region, where a particular wifi or Bluetooth or blue tooth signal.

In a retail settings a device 2499 with these emitters 2403 comprising of 125 and/or 115, may be placed with codes that corresponds to items other than plant sensor devices comprising of a subset of the components and functionality of the sensor 199. When the “google glass” device 2407 mounted with functionality 2405 which exists or needs to be added to the glasses detects using a camera and/or infrared sensor 2411 and software 2412 the identification code 2404 generated by software 2406 along with optionally the approximate store location as one example, or with just the code on it's own, it looks up the identification code on a local or remote database 2408 to retrieve 2410 product information 2401 that is then displayed on the “google glass” display 2409 for the user including helpful information that may encourage the user to buy the item such as a video of features. The “google glass” device can also retrieve product data 2401 from the device 2499. If the device such as “google glass” can sense infra red then using infrared as the emitter may allow more accurate detection of the pulse train used for identification especially if hardware or software filters can be applied. The identification code and other information can be assigned by to a device use lower power RF or alternately using a light sensor as the communication technique using signals as infra red or the visible light from an external device such as the mobile computing device 399 where the signals are generated by software 302 in the mobile computing device 399 using infra red emitter or display screen 305 of the mobile computing device 399 to generate visible light signals. As another alternative, the plant sensor device 199 or other device such as used in retail with a subset of the components and functionality of the sensor 199 can instead of transmitting regularly operate in a mode where it uses an infra red sensor 123 to wait for the detection of the described infra red signal including identification code of the user emitted from a device such as “google glass” the retail device using a subset of 199 can the either transmit a code back using its infra red transmitted which is received by the “google glass” infra red receiver or using other techniques to communicate an identification code for the retail item associated with the device using for example low power RF. When the device 199 regardless of use for plant monitoring, retail or other application can transmit or be ready to receive information only when the accelerometer measures movement of the device for example in the case of retail applications the lifting of a shoe by an interested customer.

In one embodiment the profile and other information may be communicated to the plant sensor device 199 using signals as infra red or the visible light from an external device such as the mobile computing device 399 where the signals are generated by software 302 in the mobile computing device 399 using infra red emitter or display screen 305 of the mobile computing device 399 to generate visible light signals.

In some embodiments, Profiles can be run in programs on both the plant sensor device 199 and or application 302 on mobile computing device 399 and or remote server 500. Some aspects of the profile can also be run on the application 302 or remote server 500 so that if for example the plant sensor device 199 cannot connect to the users mobile computing device 399 or remote server 500 then the calculations can be made to estimate when activities such as watering should have been performed in the absence of sensor values from plant sensor device 199. Some activities that are purely time, needing no input from sensed values on the device 199 such as re-potting seeds after 4 weeks or fertilising every 4 months can be calculated.

When the plant sensor 199 and the application 302 on the mobile computing device 399 are connected profile evaluation or calculation to identify tasks to be done can be done in code on either devices 199 or 399.

In some embodiments, It may however be more appropriate that sensor calculations are done on the plant sensor 199, so that alerts are generated only when they are required reducing connection time and battery usage on the device 199.

In one embodiment the plant sensor 199 may indicate that it has an alert simply by turning on it's devices radio to be discoverable. This may simplify the task for the mobile computing device 399 to receive alerts as it simply needs to connect when it sees the plant sensor is discoverable. In this configuration the mobile computing device will have a background service to monitor for this event of the device becoming discoverable.

In one embodiment, The profile can incorporate a range of alternate care strategies dependent on conditions such as geographical location and climate which can be known through the location of the plant based on the mobile computing device's 399 GPS. As one non limiting example, if there is no temperature sensor on the plant sensor device then a lookup of the present temperature from a remote server including for example belonging to a weather service provider. When selecting seeds to plant the location may be used to lookup a database which can return the appropriateness of a seed for a given location similar to the function performed to the graphical map shown on the back of seed packaging to shown areas where the seed is suitable to be grown.

In some embodiments, When several plants are in the same location the profiles could also be combined and designed for a set of plants that seek to build a common set of care algorithms that approximates an average set of care person(s) activities that will suit the plants in the group.

In some embodiments, Actions can be set up to be initiated when conditions change without being simply as a result of sensor reading being out of range. For example in the case of an indoor plant, temperature may not be out of range but the higher temperature, for example caused by indoor heating in winter may mean that the calculated time to re watering may need to be shortened

In some embodiments, Calculations can be done to determine how much a water a plant receives and how quickly the soil dries out as a function of the soil type, temperature, light, humidity. An algorithm can then predict as the multiplicity of values are measured how much time will elapse before re watering or other care is required to warn the user in advance. During a garden setup phase, the use of this calculation may be helpful to plan out a garden by identifying groups of plants that can coexist and easily be managed.

In some embodiments, the plant profile can monitor the following activities,
Ensure that the moisture will be within a set band if falls below watering is requested from the user or automated device
Alert when fertiliser should be applied
Ask the user if fruiting is occurring and make calculation on aspects such as higher watering needs and proactive against heat and frost
Alert the user to move a plant into shade. This may be a seasonal movement, permanent suggestion or for a particular short term weather event
Apply new moisture profile because of fruit is now growing
Remind the user to check after a period of days for germination of seeds and to replant into bigger pots
Check for pests after certain weather patterns and advise on treatments
Alert if the temperature is too low or high as the profile sets upper and lower extreme limits as well as if the general temperature range is not ideal. Shade clothes, for heat or terrarium or greenhouse for cold may be suggested solutions to bring the environmental conditions back into the desirable range. In the case of a sudden cold snap or hot day the user can be quickly alerted to save the plant
Alert if humidity is outside of range
Yearly cycles of care needed, for example pruning at certain times.

In one embodiment, Taking as an example the care of seedlings, An expert would counsel that the seeds be used in spring, they require 20 degrees soil temperature, continuously moist soil, 70% humidity and full sun. They will germinate after 20 days and be fruiting after 40 days at which time they require fertiliser and extra moisture. To translate this advice into practice requires remembering and having the skill to check the temperature, moisture, sun light and humidity as well as having a device to do this and being able to take sampling overtime and being able to know what steps to take based on the measurements taken. For seedlings the sensor 199, or even a detachable probe 132 section with a connector to allow connection to the remaining device 199 can optionally also be attached to a special seedling cup or box with probe for moisture and temperature at the right height. When the profile is setup for full to partial shade, if the light and or temperature are excessive then the profile and the device can together determine for the user the reduction in shade required to achieve the correct lighting, It may for example tell the user that a 20% reduction in sunlight will help the plant more. Presently in known art, a simple precursor to the concept of a profile can be found in the guidelines on a seed packet “shared” by seed manufacturer.

In some embodiments, the profile system described here goes beyond said package instructions in the following ways. Firstly, the advice is captured as expert system rules Where the rules may have several conditions and then associated actions to perform when the conditions occur. Secondly, The rules are developed and then shared on an advice sites. They may also place links to the profiles on seed packets, brochures, of gardening pots and other items. Experts may also be professional or novice. Thirdly, The rules are downloaded to an application 302 on a mobile computing device 399 and or the plant sensor device 199 located in proximity to the target plant Fourthly, The application 302 on a mobile computing device 399 and or the plant sensor device 199 runs the rules and generates advice alerts Fifthly, The application 302 on a mobile computing device 399 share progress of plants to other users as well as vote on, modify or comment about the profile on remote servers such as advice sites

In an alternatively embodiment the rules are not shared instead compiled code generated representing the rules is shared.

In some embodiments as Keeping plants indoor can be difficult. The profile can also be set to known that the plant being monitored is indoor so that activities specific to indoor plants can be alerted, For example if sunlight received by the plant is low then the system can suggest moving the plant outside.

One embodiment of an example of a profile for a strawberry plant is shown in FIG. 18

The profile specifies stages of the plant growth such as Seed, Seedling, Small Plant and Plant. To determine the stage of the plaint, either the time the plant has been growing is used to determine the stage of the plant or alternative the user inputs the stage of the plant.

In one embodiment of an example of a simpler profile such as shown in FIG. 19 for a plant succulent from a nursery may be simply can be created.

In some embodiments, The profile method allows these rules to be configured in code, graphical representations or as rules with states, properties and actions as described. A range of different languages such as basic, C, javascript, python as some examples can be supported for the code. The code can access date and time information as well as GPS location information in order to remember actions and events that repeat or detect changes in season as well as store values in memory for long term calculations.

For example a c style language

if (temperature > 40) && (moisture < 40%)
{
Alert User plant needs watering
}

in one embodiment Sharing of Profiles is enabled.
To achieve the profile system described above, the system gives
1. The ability to create a profile of attributes to monitor and action to take (based on the status of the attributes) that are then monitored by the device acting on a plant

### AND,

2. Collect information about the plant (possibly also requiring interaction with the user).

### AND,

3. Alert the user of actions to take, or send commands to automatic equipment AND,
4. the ability to share, rate, improve and adapt the profile are both necessary attributes of this system.

Referring to FIG. 5a, a device 399 may be used to generate a plant type profile 501 which is then uploaded 502 to a remote server 500 to be shared. A second user may download the same profile 503 to their mobile computing device 399 and then download 504 to the plant sensor device 199. The profile is shown as 501. Other users may also download, use, and also vote 505 on the profile as well as adapt it and republish it.

An important aspect of these profiles is that they can be created and shared by all users of the device for themselves as perhaps amateur gardens to share with others as well as expert gardens such as plant growers, government, gardening show presenters, seed companies. These profiles are stored on a remote servers. A user may also make and store a profile for himself kept on his own Mobile computing device 399 or computer. He has the option to also share this profile on the remote server.

In one embodiment, along with the profile plant care/growing instructions including pictures, text and video can be also be created and shared. When actions for the user to carry out when conditions are triggered in the profile are configured then these action instructions can include detailed pictures, text and video to help them carry out the action. For example, a profile may have condition for pruning every end of summer and in the action it may specify that pruning should be done providing said detailed information in the form of pictures, text and video.

In one embodiment, Where the user does not own a plant sensor device 199 as described here, or perhaps just the application 302 on a mobile computing device 399 the profiles for plants the user is monitoring can still be downloaded and the user can manually check aspects of the plant that would in the possessing of a monitoring device have been ascertain by the device. The profile will still have considerable utility. Additionally in the absence of the plant sensor device 199 online sensor information such as weather information can be used by the application 302 looked up using the mobile computing device's 399 gaps. A grid of one or more sensor values from other users plant sensor devices 199 uploaded via their mobile computing devices 399 with the location of those devices can be uploaded to a remote server 500 from where other users can use these sensor values if they have no sensor as described or combined with their sensor value.

In one embodiment, users can Vote, Rank, Classify profiles according to area, modify and republish and searching a common remote server accessible by users.

In one embodiment plant type profiles could also be created for sale on a server of offered for free with advertisements served when the user accesses the profile on a server or downloads and runs the profile on a mobile computing device 399.

In one embodiment, plant type profiles could be run on the application 302 without the plant sensor 199. Properties such as light, temperature, and humidity could be manually entered by the user where the application 302 could optionally also use a timer to ask the user to manually assess any of the properties regularly. Corresponding rules comprising of conditions and actions for lifecycle stages of the plant for individual properties such as soil moisture of the plant would then be evaluated and actions or instructions sent to the user to perform. As an alternative to manual assessment by the user, the sensor values could be obtained from remote server hosting weather information such as rainfall and temperature and sunlight for the day and time of year from which these properties can be estimated. The remote server can also host sensor values from plants nearby which have been reported to the remote server by these other plant sensor devices 199 using for example a mobile computing device 399 to upload the values. Alternatively, any sensor device 199 within range of the mobile computing device 399 communicating with low power rf can provide sensor values.

In one embodiment, plants could be sold with plant sensor device that has been preloaded with the profile of the plant.

In one embodiment, the plant sensor device can be used as a Seed or Plant Selection Guidance Device. In planning a garden, a user may have one of the following options in mind Either to firstly Begin with a set of plants that the user wishes to plant, or either secondly to Have broad types or classes of plants desired in mind for example, flowers, succulents, herbs, vegetables but be open to a suggestion of best plants to grow or thirdly be open to the suggestion of any plant. The system can be used to suggest the best plants or suitability of a desire plant to grow in a particular garden location. Seeds, seedlings or establish plants can all be selected. The system use GPS or user input to determine the location of the garden, it also collects information about the users skill as input by the user, the user's availability to perform care of the garden such as watering, time of day watering is possible by the user. It may also ask the user to input the size of the pot if a pot is to be the location. It then optionally also asks the user to insert the plant sensor device 199 into the soil near where the plant will be grown. The device may be left there for a period of time during which it learns what the environment is like, for example sunlight, whether shade or direct or partial sun, as well as soil moisture, characteristics of the soil such as how much water it absorbs how the water sits at various layers in the soil.

In some embodiments several different methods can be used to determine the amount of shade, FIRSTLY, if two plant sensor device's 199 light sensors 106 are used, one is placed in the full sun the other in the plant position. The difference between the two sensors measurement of temp and/or light is then the percentage shade. SECONDLY, one device 199 is placed in the soil and it records sunlight. To avoid confusing cloud and shade it tries to locate peak values of sunlight where the change is quicker it can assume that the quick moving shade is by clouds. THIRDLY, The device 199 is placed in the soil for an extended period of time and the values for sunlight and temperature and moisture are used to calculate the sun/shade characteristics of the area.

In one embodiment, To measure average moisture content the sensor can be left for a long enough number of days to make a determination of the amount of rain, or alternatively an internet base value used, or a rain gauge can be used.

In one embodiment, Referring to FIG. 9, in order to determine the characteristics of the soil the sensor can sense when water flows into the soil and determine the rate it is lost as well as whether it sits in a particular zone for example the roots. In a precise way the system can ask the user to pour a specified amount of water which the system then uses to measure the response of the soil.

In one embodiment, Humidity and temperature can be determined by leaving the device 199 in the ground for an extended period of time. When the user is Beginning with a set of plants that the user wishes to plant the recommendation is made by taking profiles of the plant selected matching with the variables discussed including soil type, soil moisture, sun light and shade, and temperature and providing a degree of suitability. If the suitability is low the system may suggest some ways to improve suitability for example place in a green house if you wish to grow plant in cold climate. Or if the soil has poor drainage, as measured by the system then re-potting with a good organic mix with better drainage characteristics.

When the user has broad types or classes of plants desired in mind but not particular plants, the recommendation is made by matching all plant profiles ranges whose moisture, sunlight, humidity match the garden location and displaying to the user to select. When a seed or plant is selected there is a mechanism where the seed can then be ordered through the application 302 on the mobile computing device 399 from a remote server and payment made by the user for the purchase seeds or also plants.

In one embodiment, The plant sensor device 199 may also be placed in an indoor setting to determine which plants could be grown in an indoor setting Care actions such as re-potting, application of fertiliser, the removal of the plant with the end of season can be sent to users depending on timers indicating the action is required. For example, when a plant is first potted, a quarter year recurring timer will be set to remind the user to reapply a slow release fertiliser. Sun light received is one such property. The device 199 can measure sunlight and when the absolute value varies from the value required by the plant as specified by the plant type's profile then the user is alerted.

According to the plant types suggested or chosen suitable fertiliser, soil type and if applicable pot sizes can be advised. The size and height of the plant will also be reported so that the user can check that there will be adequate space for the plant. Different Plant types often vary in water needs and hence watering frequency required from the user. As one example, succulent plants designed for the desert may not need watering despite the moisture reading being dry whereas another plant may require watering for the same temperature.

One embodiment of referral system When a profile has been run for a plant and finished the system can suggest other plants profiles that would be suitable for the location, time of year for the next planting. It can also provide a means to purchase these through the system or suggest locations from which the plants can be purchased. In one embodiment Control elements can receive commands from the plant sensor device or mobile computing device and change aspects of the plant's environment. In addition to measuring sensor devices the system can also control inputs into the plants environment based on signals generated by the system in response to actions executed by a plant profile. In one embodiment, the plant sensor device 199 or the mobile computing device 399 communicate with the control elements using low power Radio such as Bluetooth 4 (or Bluetooth low energy) and send commands.

Various control elements include, Firstly, a shade cloth that can be extended and retracted to increase and decrease shade by a motor. Secondly, fans that can be fitted in a terrarium or green house to control temperature. Thirdly pumps that can be activated to the watering the plant(s), Or fourthly drip feeder system that can be activated to water the plants. When the system and these control elements combined they can control for example a terrarium for an indoor controlled eco system allowing profiles that could not be normally survive outside for example, growing a tropical plant in a snowy winter climate.

In one embodiment for children and students, the growth of the plant, and the amount of sunlight, moisture, temperature, co2 and other factors can all be plotting or graphed so that they can understand the effects of different combinations on environmental stimuli input on plant growth. The student can then create a profile that controls the care of the plant or whole terrarium eco system. Control elements could be used for example to turn on the fan of the ideal temp is exceeded. The profile provides the ability through a programming language or rules to control the amount of input to the plant for example control the speed of the fan or amount of watering in a way that is proportional to the rise in temperature or dryness of the soil. The system turns to the child's interaction with the garden into a game.

In one embodiment as a game for younger children Referring to FIG. 7, each plant is assigned a code such as QR code or bar code 700 placed with the plant in garden 796. Optionally the plant is also named and this name is stored associated with the QR in the Mobile computing device's 399 memory. The game involves the child trying to remember to care for the plant and receiving rewards when she remembers to for example care for the plant by watering it. The child then using the Mobile Computing Device 399 then scans the code 700 using the mobile computing device's 399 camera 306, and then the application tells the child the name of the plant in an engaging way and then prompts the child to check the moisture. The application 302 on the mobile computing device 399 then tells the child if the plant requires watering. But it does this using wording that creates the impression for the child that the plant told the child “please water me” or “I′m not thirsty today” If the child forgets she is then reminded by a small timer they keep with them built into device 299, or by the phone application 302, or alternatively to the timer, the plant sensor device 199 reads the moisture is dry to check the plants by some kind of alert. She may loose some points or receive less points for needing to be reminded.

In another embodiment, the child scans the plants code and the mobile computing device 399 receives the information from the sensor 199 associated previously with that plant and then tells the child directly if to water or not. At stages the system prompts the child to record the process of plant development by pictures and video which the system can overlay with the measured values so that users can see the connection between the measurements such as moisture, temperature and the plant growth The child can then receive points and rewards as they care for the plants. They can take pictures of the plant as it develops and share with others.

In one embodiment, If the plant requires watering then the amount of water required is calculated based on either previous water applied or calculation of needs based at least initially on the type and size of the plant as well as the soil type's effect on the ability of the plant to absorb the water before it runs away as one example. The amount of watering required also depends on the present moisture level with higher moisture levels but just below the acceptable water level requiring less additional top up watering.

In one embodiment, Plants from flower shops could also be sold with the plant sensor device 199. The plant sensor device may be locked to only operate for single plant type and be sold at cost, but the user can subsequently unlock the plant sensor device 199 to operate on other profiles.

In one embodiment, when the plant label 1600 is scanned, the Plant store location and age of plant, date stocked in store, and other such can be specific information can be stored in the QR code, or looked up on a server using the code, and used by a server process to run a retail system wherein various algorithms are applied, which may have information about other plants types that are similar to the one purchased by the user or may suit the conditions of the plant as read from the plant sensor device uploaded. The QR can be cross linked with sales data to identify the dates, cost and volume types amount of purchases. Firstly to Allow the original store to use this uploaded QR or bar code information to recommend new plants or complement goods or services. Secondly Allow a group of stores to have this purchase history to compete, bid or other wise buy the right to make a sales suggestion to the another or thirdly to Provide updated products, caring information or articles.

In one embodiment, the accelerometer 121 on the plant sensor device 199 which may be attached to the sensor directly of be connected by a wire so that it can be placed on a plant to warn of movements such as animals eating the plant or its fruit or in other ways interfering with the plant. A passive infrared sensor 125 can also be used to detect movement at night. When movement is detected a light 114, alarm 115 or to message to the mobile computing device 399 can be sent.

In one embodiment the user can take pictures of plants for example, diseased damaged leaves using the Mobile Computing Device 399 and upload them to a database where they can be matched automatically using image correlation and other techniques or manually matched and care information sent back to the Mobile Computing device 399.

In one embodiment the health of a plant can be determined by measuring how it reflects light. For example, a plant with leaves with healthy chlorophyll levels will reflect less visible light and reflect more near infra-red. Healthy levels of water absorption can be determined by the reflectance of the plant's leaves of shortwave infrared. Analysis of a plants spectrum of absorption and reflection in the visible and in infrared wavelength is very useful in providing data about a plants health. Each plant type has unique patterns and ranges for reflectance and healthy variations in these patterns.

In one embodiment properties can be defined not only as “temperature” but also as “day time temperature” and “night time temperature”. Of the property can be temperature but the condition can combine time and temperature to specify different conditions and actions depending on the temperature and time of day. As an example, the Moth Orchid, Phalaenopsis requires 20 degrees Celsius or higher in daytime and 16 degrees of higher at night. Two properties, “day time temperature” and “night time temperature” can be specified. The “day time temperature” property with conditions “less than 20” will be defined to have the action “the temperature is too low place the orchid is a more sunny location or green house or turn up the heating”. The “night time temperature” property with conditions “less than 16” will be defined to have the action “the temperature is too low place the orchid turn up the heating in the house or green house”. Alternatively the plant profile could contain only one property “temperature” and in the conditions use code to specify the condition for example “if(time==night AND temp<16)”.

In the case of another orchid, Oncidium, the temperature range is more stringent and critical to a good bloom. During the day 18 to 24 degrees Celsius and night 13 to 16 degrees. The conditions should allow upper and limits to be able to be specified.

In one embodiment, the mobile computing device camera can be used to scan existing plant care labeling images and text and then image recognition and text recognition used to match the symbols and text to plant care instructions and from these generate a plant care profile.

In one embodiment, the plant sensor may also be placed at the base of the stems of cut flowers, which are often expensive, to ensure that the moisture level is adequate and the temperature level is appropriate warning when the temperature varies due to drafts, hot spots including from appliances such as TV sets or too much direct light. By monitoring the life and appearance of the cut flowers can be extended.

In one embodiment, if the plant is edible such as a fruit or vegetables then links to recipes in which the plant can be used will be provided. This may be particularly engaging for children.

In one embodiment, the plant profile provides the ability for skillful gardeners or garden shops, or gardening books or magazines to communicate complicated plant caring instructions in a way that is simple for a plant owner to follow by using the coding language and or symbols to capture the detailed instruction in a manner which can be displayed to the user in small simple instructions when an action is required. This allows retailers, book publishers, TV programs, magazines and the like to differentiate themselves by the quality and knowledge provided by the material and interactive plant care instructions. Consider for example the care of a certain citrus plant where the instructions are as follows, “During the warmer months water 3-4 days a week, even more so when fruit is noticed and when it is very warm. Fertilize in spring and also in late summer being careful not to touch the bark. Prune in later spring.” The system can support time and season related variables and functions that can be used in the program for example, functions such as a “IsWarmMonth( )” returns true when the month is December, January, February and the plant is situated in the southern hemisphere. In a similar way “spring”, “late summer” can be assigned time definition. When applied to a plant IsDry( ) in addition to percentages or fractions there is lots of flexibility. The program in this way is easy to configure by for example a gardener/shop owner as well as easy for the plant caregiver/user who only needs to follow one part of the instructions which are relevant at that time.

In one embodiment, the plant care profile can also have advertisements embedded as part of the profiles so that for example, when it is time according to the profile to fertilize, it recommends a product by hardcoded image, text, video that downloaded with the profile or via a link to fertilizer on the a website or downloaded into the application.

In some embodiments, users can share pictures and data and actions taken and products used from successful plant profiles and recommend the profile to other people.

In one embodiment, if the user goes away from the plants for example for a holiday then a mobile computing device can be used as bridge to communicate the sensor values to a neighbor or a plant company which will look after the plants. This same technique could also be used for plant services companies remotely monitoring plants.

In one embodiment, the plant sensor device can be sold at a discount but being configured to serve to the user advertisements or interactions such as receiving tips or recommendations for new plants or gardening equipment or other products as it performs it's functions. This configuration can be achieved by various forms of locking the device such as the setting of a code or hardware setting. Alternatively, a code can give the user access to special plant profiles not available to other users or cause the user to receive additional suggestions for future plants that can be grown that match the conditions that the plant sensors measures currently and match suitable profiles in a database. When the plant sensor values are out of range such as the moisture in the pot is too high then the moisture reading can be used as a trigger to suggest that a larger pot size is needed and advertising for alternative pots shown. This allows continual selling through the data provided from the sensors to be achieved. When the plant sensor code is disabled, the user can access all content that is shared either for fee or free, the code can be removed in software, hardware or otherwise disabled. Up sell up sell if going away the can search database for plant caregiver temporary. Agree based on place. The user can also allow a company access to the sensor data coupled with photos or video in situations where advice is needed about for example plant diseases or other plant problems and a remote expert receive a fee or advertisement shown in exchange for reviewing the data, photos and video to make recommendations and give gardening advice based on also the past history of plant, and for example seeing the plant not doing well because of lack of fertilizing sell fertilizer at a discount and so in this manner use physically sensed gardening data as data that is matched to find suitable plants, equipment or treatments as a recommendation engine.

In some embodiments, the plant profiles can be shareable to only a group of users, all users, or a user only able to access a set of profiles.

In some embodiments a Lesson group mode is anticipated where students makes and test against plants results uploaded to a server for sharing group and or teacher.

Some of the advantages of such the plant sensor network and associated system include: Firstly, it automates the measurement and decision making process to care for plants so that a user does not need expert knowledge or skill; Secondly, Provide a method to select the best choice of plants for a situation or check if a plant will survive in the selected conditions; Thirdly, Based on measurements made the system can also automate the control of the plant's environment by for example controlling watering as show in FIG. 14l; Fourthly, the system provides a mechanism to download plant profile information about a plant from experts or upload a plant care profile for sharing with others; Fifthly, the sensor device can be configured using rich user interface and then monitor a system in the absence of mobile computing device and the plant sensor device will only attempt to connect when care event is generated so as to reduce battery usage.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

An embodiment of a Plant Profile Management system includes at least one processor coupled directly or indirectly to memory elements through a system bus such as a data, address, and/or control bus. The memory elements can include local memory employed during actual execution of the program code, bulk storage, and cache memories which provide temporary storage of at least some program code in order to reduce the number of times code must be retrieved from bulk storage during execution.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, including an operation to monitor a pointer movement in a web page. The web page displays one or more content feeds. In one embodiment, operations to report the pointer movement in response to the pointer movement comprising an interaction gesture are included in the computer program product. In a further embodiment, operations are included in the computer program product for tabulating a quantity of one or more types of interaction with one or more content feeds displayed by the web page.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Embodiments of the invention can take the form of an entirely hardware embodiment, an entirely software embodiment, or an embodiment containing both hardware and software elements. In one embodiment, the invention is implemented in software, which includes but is not limited to firmware, resident software, microcode, etc.

Furthermore, embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Input/output or I/O devices (including but not limited to keyboards, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types of network adapters.

1. A plant profile watering system, the system comprising:
a mobile computing device containing at least one plant type profile;
a processor, wherein said processor executes rules according to said plant type Profile;
a radio link, wherein said mobile computing device transfers said plant type profile using said radio link to said processor;
at least one water controller connected to said processor, wherein said water controller receives signals from said processor, and whereby the timing and quantity of water flow to at least one plant is output.

2. The plant profile watering system of claim 1, wherein said processor has at least one sensor attached, wherein said at least one sensor acquires plant environment measurements, wherein said plant environment measurements are used in said execution of said rules according to said plant type profile by said processor.

3. The plant profile watering system of claim 1, wherein said processor is a plant sensor device with at least one sensor attached, wherein said at least one sensor acquires plant environment measurements, wherein said measurements are used in said execution of said rules according to said plant type profile by said processor.

4. The plant profile watering system of claim 2, wherein said processor executes said rules according to said at least one sensor acquiring said plant environment measurements including air temperature, soil temperature, humidity, soil moisture, soil water drainage and sunlight.

5. The plant profile watering system of claim 3, wherein said processor executes said rules according to said at least one sensor acquiring said environment measurements including air temperature, soil temperature, humidity, soil moisture, soil water drainage and sunlight.

6. The plant profile watering system of claim 1, wherein said processor is a plant sensor device with a water sensor attached, wherein said water sensor acquires soil moisture readings, wherein said soil moisture readings are used in said execution of said rules according to said plant type profile by said processor.

7. The plant profile watering system of claim 6, wherein said timing and quantity of water flow to output to at least one plant is determined during execution of rules by calculating the difference between said soil moisture readings and the required soil moisture reading according to the selected plant type profile.

8. The plant profile watering system of claim 1, wherein said processor has a soil moisture sensor attached, wherein said soil moisture sensor acquires plant environment soil moisture, wherein said plant environment soil moisture measurement is used in said execution of said rules according to said plant type profile by said processor.

9. The plant profile watering system of claim 1, wherein a plurality of plant type profiles determines the timing and quantity of water output by a plurality of water controllers to a plurality of plants.

10. The plant profile watering system of claim 1, wherein said processor has a plurality of sensors attached, wherein each said sensors is associated with at least one plant type profile and one water controller, wherein said processor can executes rules according to said at least one plant type profile, whereby the timing and quantity of water flow to at least one plant is output.

11. The plant profile watering system of claim 1, wherein said water controller includes a multiplicity of combinations of water flow control valves driven by electrical or mechanical actuators including solenoids.

12. The plant profile watering system of claim 1, wherein said water controller includes water flow control valves activated by a solenoid receiving signals from said processor, whereby the timing and quantity of water flow to at least one plant is output.

13. The plant profile watering system of claim 1, wherein said water controller receives electric signals from said processor by electrical conductors including wires.

14. A method of watering plants according to a plant type profile, comprising:
a. connecting a mobile computing device to a plant sensor device,
b. communicating at least one plant type profile from said mobile computing device to said plant sensor device,
c. executing said at least one plant type profile according to time, location or sensor measurements as determined by said plant sensor device,
d. controlling water flow by said plant sensor device as determined by said execution of said at least one plant type profile,
whereby the timing and quantity of water flow to at least one plant is controlled.

15. A plant selection guidance device, the device comprising:
a plant sensor device configured to measure sensor readings in proximity to at least one plant;
a mobile computing device coupled by a radio link to said plant sensor device, wherein said mobile computing device is configured to receive said sensor readings by said radio link, and wherein said mobile computing device compares said sensor readings against a database of plant type profiles, wherein the plant type profile comprises acceptable ranges for said plant, and whereby said mobile computing device is further configured to recommend at least one suitable plant type.

16. The plant selection guidance device of claim 15, wherein said radio link is bluetooth low energy or bluetooth smart.

17. The plant selection guidance device of claim 15, wherein said database of plant type profiles may be created by a multiplicity of users uploading created plant profiles to said database of plant type profiles.

18. The plant selection guidance device of claim 15, wherein said database of plant type profiles may be created by a multiplicity of users uploading created plant profiles to said database of plant type profiles, whereby other users can select said created plant profiles for download to a mobile computing device.

19. The plant selection guidance device of claim 15, wherein said sensor readings used to select a suitable plant type profile include, sunlight, time of day of available sunlight, water soil drainage, humidity, soil acidity, soil moisture, air temperature, soil temperature, in addition to which time of year and geographic location and associated weather conditions may also be considered.
